(19) United States
(12) Patent Application Publication
(10) Pub. No.: US 2011/0033776 A1
(43) Pub. Date: Feb. 10, 2011

(54) PROTON EXCHANGE MEMBRANES

(75) Inventors: Alan Fuchs, Reno, NV (US); Joko Sutrisno, Reno, NV (US); Anasuya Adibhalta, Reno, NV (US); Chaitanya Ravipati, Reno, NV (US)

Correspondence Address: WOOD, HERRON & EVANS, LLP, 2700 CAREW TOWER, 441 VINE STREET, CINCINNATI, OH, 45202, US

(73) Assignees: Board of Regents of the Nevada System of Higher Education, on behalf of the University of; Nevada, Reno, Reno, NV (US)

(21) Appl. No.: 12/853,912

(22) Filed: Aug. 10, 2010

Related U.S. Application Data
(60) Provisional application No. 61/232,651, filed on Aug. 10, 2009.

(51) Int. Cl. H01M 8/10; C08G 73/06

(52) U.S. Cl. 429/492; 528/125

(57) ABSTRACT

The present invention is directed to proton exchange membranes such as for use in fuel cells. In one embodiment, a polyetherquinoxaline is obtained by reaction between a haloquinoxaline and at least one diol, which forms a repeating unit including an ether linkage. The polyetherquinoxaline is suitable for use in a proton exchange membrane, which can be used in a fuel cell.

### CROSS-REFERENCE TO RELATED APPLICATIONS

This application claims the benefit of and priority to prior filed co-pending Provisional Application Ser. No. 61/232,651, filed Aug. 10, 2009, which is expressly incorporated herein by reference.

### STATEMENT REGARDING FEDERALLY SPONSORED RESEARCH OR DEVELOPMENT

The invention disclosed herein was made with support awarded by the National Science Foundation STIR-AMAD, Inc. and The Department of Energy. The government has certain rights in the invention.

### FIELD OF THE INVENTION

The present invention is directed to proton exchange membranes such as for use in fuel cells.

### BACKGROUND OF THE INVENTION

Proton exchange membranes (PEMs), which are also known as polymer electrolyte membranes, play a central role in fuel cell operation. Fuel cells have great promise as environmentally friendly power sources and efficient energy systems. The fuel cell system generally includes the following components: an anode, a catalyst(s), a PEM, and a cathode. In the fuel cell, PEMs provide three main contributions, which include functioning as ion transfer media, separating reactant gases, such as hydrogen and oxygen, which react at the cathode and anode, and functioning as a catalyst support. (He, R. et al., Journal of Membrane Science, 277, 38-45, 2006). Proton exchange membranes with high ion conductivity, low gas permeability, and high mechanical strength are desirable.

Nafion® (E.I. Du Pont de Nemours and Company), a perfluorosulfonic acid polymer, is used for current state of the art PEMs, Hydrated Nafion® membranes have high proton conductivity and are used at temperatures up to 80° C. Above that temperature, they release water and the proton conductivity decreases. Because of the limitations of Nafion®, researchers have been developing non-perfluorosulfonic membranes. Some of these limitations include high cost, low conductivity due to water loss at high temperature, low humidity and high permeability to methanol. (Mecerreyes, D., et al., Chem. Mater, Volume 16, 2004, pp. 604-607.)

The Nafion® ionomer has a hydrophobic backbone and hydrophilic ionic functional groups. The hydrophilic and hydrophobic regions tend to display phase separation, with clustering of the hydrophilic ionic groups. Separation of hydrophobic and hydrophilic regions has also been reported in alternate PEM materials, such as sulfonated polysulfones (U.S. Patent Application Publication No. 2003/0091225 to McGrath et al.) and polymer blends (Swier, S. et al., J. Membrane Science, 270(1-2), 22-31, 2006; Swier, S. et al., J. Membrane Science, 256 (1-2), 122-133, 2005). The morphology of the polymeric material can also depend on supramolecular interactions other than hydrophilic-hydrophobic interactions. These interactions include acid-base interaction and hydrogen bonding. Phase separation can result in unique structures with both proton conducting and non-conducting phases.

Membranes that are composites of a solid acidic inorganic material and a polymer electrolyte have also been proposed. (Malhotra, S., et al., 1997, J. Electrochem. Soc, 144, L23; Thampan, T., et al., 2005, J. Electrochem. Soc., 152(2) A316-A325). Heteropoly acids (HPAs) have been studied extensively. (Meng, F., et al., Electrochimica Acta, (53), 1372, 2007; Vernon, D., et al., Journal of Power Sources, (139), 141, 2005; Malers, J., et al., Journal of Power Sources, (172), 83, 2007). In addition, it was reported that incorporation of phosphotungstic acid (PTA) into Nafion® can provide high proton concentration and improved water retention. (Malhotra, ibid; Kim, H., et al., J. Membr. Sci. 288(1-2), 188, 2007). Composite membranes of HPAs and polybenzimidazole (PBI) have also been studied. (He, R. et al., J. Power Sources (172), 83, 2007.) Proton transport can occur by vehicular or diffusive transport or “hopping” or Grotthuss transport; both of these mechanisms can be influenced by the humidity level. The use of HPAs in Nafion® membranes was reported to increase proton transport because of a decrease in the membrane resistance to “hopping”. (Ramani, V. et al., J. Memb. Sci., 232, p. 31-44, 2004). However, water solubility of HPAs can lead to leaching of the HPAs from the membrane.

Composite membranes that include solid acidic inorganic particles may include surface-coated HPAs or montmorillonite, which have been reported to increase the membrane mechanical properties while maintaining high proton conductivity. In addition, the surface-coated HPAs offer additional advantages, such as increasing the compatibility between polymer matrix and HPA. Further, surface-coated HPAs may also be grafted onto a polymer back bone and thereby increase the conductivity by introducing sulfonation to the grafted polymer backbone, and grafting further avoids “washing out” of HPA in the fuel cell.

Crystallinity is another important issue for PEMs because of the issue of methanol crossover. A composite membrane of Nafionahydroxyapatite (HA) that has high crystallinity showed a decrease in the diffusivity of water-methanol and methanol crossover as the HA content increased. (Park, Y. S., Polymer Bulletin, Vol. 53, pp. 181-192, 2005). The incorporation of heteropoly acid (HPA) into Nafion® has resulted in better mechanical strength, presumably attributed to increased membrane crystallinity. (Shao, Z. G., Solid State Ionics, Vol. 177, pp. 779-785, 2006). The hydrophilic character of HPAs can increase the proton conductivity because of the change of membrane crystallinity, which has stronger interaction between the polymer matrix and absorbed water. (Shao, Z. G., Solid State Ionics, Vol. 177, pp. 779-785, 2006).

Many alternate PEM materials have been developed, including materials based on styrene, polyimide, polyphosphazene, polybenzimidazole (PBI), and polybenzoxazole (PBO). PBI has no proton conductivity but it has excellent chemical and mechanical stability with a glass transition temperature of approximately 420° C. (Bouchet, R., et al., Solid State Ionics, 2001, 145, 61-78). There are several modifications that can be utilized to make PBI suitable as a proton exchange membrane material, e.g., acid doping, synthesizing a composite with an inorganic proton conductor, and direct synthesis from sulfonated monomer. Polyimide is also well known as a high temperature polymer. And sulfonated polyimides have been proposed for use in fuel cells. (U.S. Pat. No. 6,376,120 to Faure et al.).

Polyethersulfones (PES) are another important and well known class of thermoplastics. This class of polymers displays excellent thermal and mechanical properties, as well as resistance to oxidation and catalyzed hydrolysis. Polyethersulfones generally demonstrate high glass transition temperatures, which may be attributed to the high strength of the sulfone moiety. Polyethersulfones generally have favorable processability, which may be attributed to the ether linkage that provides flexibility to the polymer. One general approach to synthesizing polyethersulfones is typically a reaction between a dihydroxy-containing molecule and a dihalide molecule.

Proton exchange membranes based on supramolecular polymers have also been developed. Supramolecular polymers are held together by a combination of covalent and non-covalent bonds. A proton exchange membrane has been synthesized using a sulfonated copolymer of 4-vinylpyridine and styrene, which allows proton transfer from a sulfonic acid group to a nitrogen heterocycle. (Maki-Ontto, R., et al., Advanced Materials, Vol. 14, Issue 5, 2002, pp. 357-361). It was also demonstrated that heterogeneous systems of conductive and non-conductive phases could be oriented to produce anisotropy in the direction of proton conduction. By shearing the membrane, large scale orientation was achieved and proton conductivity was 2.5 times higher in-plane.

Supramolecular polymers can be defined as polymeric arrays of monomeric or polymeric units that are self-assembled by reversible and highly directional secondary interactions, which include hydrogen bonds, metal bonds, π-π stacking, donor—acceptor associations, electrostatic interactions, organometallic interactions, hydrophilic-hydrophobic interactions, liquid crystal interactions, metal-terpyridine (such as Zn²⁺-terpyridine) interactions and van der Waals forces, resulting in polymeric properties. These polymers often have the capability of “self-assembly”. There are two general approaches to synthesize supramolecular polymers. (St. Pourcain, C. B., et al., Macromolecules, 28, 4116-4121). In the first approach, non-covalent bonding occurs on the side chain of a polymer, thereby, forming a cross-linked, supramolecular system introducing new properties into the polymer system. In the second approach, the supramolecular polymer is formed from small molecules or oligomers between which non-covalent bonds, such as hydrogen bonds, form as part of the main chain.

Among the previously mentioned secondary interactions, metal-ligand bonds exhibit both strong and directional interactions, wherein the selection of metal ion and ligand dictate association. (Calzia, K., et al., Macromolecules (2002), 35, 6090-6093). Several supramolecular systems involving metal-coordination bonding have been reported. Terpyridine-terminated polystyrene-block-poly(ethylene oxide) coordinated with transition metal chlorides (i.e., ruthenium ions) have been reported. (Al-Hussein, M., et al. Macromolecules (2003), 36, 9281-9284). Poly(4-vinylpyridine) coordinated with 2,6-bis(octylaminomethyl)-pyridine and zinc dodecylbenzenesulfonate (Zn(DBS)₂) has been reported. (Valkama, S., et al., Macromolecular Rapid Communications, (2003), 24, 556-560). Systems based on a 2,2′:6′,2″-terpyridine-based polymer have also been reported. (Schubert, U., Macromol. Symp. (2001), 163 177-187; Schubert, U., Macromol. Rapid Commun. (2000), 21, 1156-1161).

Metal-coordinated terpyridine polymers provide an approach to supramolecular systems resulting in outstanding properties as redox polymers. (Potts, K. T., et al., Macromolecules, 21, 1985-1991, 1988). The stability of the metal-coordination in terpyridines has been improved through appropriate selection of monomers with the proper location of the acrylic group on the terpyridine linkage. Atom transfer radical polymerization (ATRP) has been used to synthesize these metal-coordinated polymers. This polymerization method provides excellent control of polymer molecular weight. In addition, crystalline metal-coordinated polymers have been synthesized. The nature of the organometallic bond has been shown to control the crystalline properties of the material. The metal-coordinated bonds provide self-assembly capability, which determines the material morphology. (Aamer, K. A., et al. Macromolecules, Published on Web Mar. 22, 2007, DOI 10.1021/ma062765i).

Notwithstanding the foregoing, there still remains a need for novel proton exchange membranes, which can serve as alternatives to Nafion®, for example.

### SUMMARY OF THE INVENTION

According to one embodiment of the invention, a polyetherquinoxaline, such as for use in a proton exchange membrane, is defined by a repeating unit including an ether linkage. The repeating unit is obtained by reaction between a haloquinoxaline and at least one diol.

According to another embodiment of the invention, a proton exchange membrane for a fuel cell is provided that includes a substrate having a polyetherquinoxaline defined by a repeating unit including an ether linkage. The repeating unit is obtained by reaction between a haloquinoxaline and at least one diol.

According to another embodiment of the invention, a membrane electrode assembly for a fuel cell is provided that includes an anode, a cathode, and a proton exchange membrane containing a polyetherquinoxaline defined by a repeating unit including an ether linkage. The repeating unit is obtained by reaction between a haloquinoxaline and at least one diol.

In yet another embodiment, a method of making a polyetherquinoxaline is provided that includes reacting a haloquinoxaline and at least one diol to form a polyetherquinoxaline having a repeating unit including an ether linkage.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a schematic illustration of a fuel cell including a membrane electrode assembly according to an embodiment of the invention.

FIG. 2 is a schematic illustration of a zinc-coordinated terpyridine linkage to form a surpramolecular bond between two blocks of polymers.

FIG. 3 is a schematic illustration of a method to form a hydrophilic channel using metal-coordinated assembly of hydrophilic and hydrophobic blocks of polymers.

FIG. 4 is a differential scanning calorimetry (DSC) thermogram of a polyetherquinoxaline (PEQ) derived from 4,4′-difluorobenzophenone and 2,3-dihydroxyquinoxaline.

FIG. 5 is a DSC thermogram of a polyetherquinoxaline derived from bisphenol A, 4,4′-difluorobenzophenone and 2,3-dihydroxyquinoxaline.

FIG. 6A is a DSC thermogram of a polyetherquinoxaline derived from bisphenol A, bis(4-fluorophenyl)sulfone, and 2,3-dihydroxyquinoxaline.

FIG. 6B is a size exclusion chromatography (SEC) chromatogram of a polyetherquinoxaline derived from bisphenol A, bis(4-fluorophenyl)sulfone, and 2,3-dihydroxyquinoxaline

FIG. 7 is a DSC thermogram of a polyetherquinoxaline derived from 2,3-dihydroxyquinoxaline, bis(4-fluorophenyl)sulfone, and cis-2-butene-1,4-diol.

FIG. 8 is a DSC thermogram of a polyetherquinoline derived from 4,7-dichloroquinoline and bisphenol A.

FIG. 9 is a reaction sequence for the synthesis of a sulfonated, imidazole-functionalized polymer.

FIG. 10 is a depiction of a metal-coordinated, supramolecular fluorinated/sulfonated block copolymer derived from a combination of the polymer in FIG. 9 and a block polymer derived from 4′-vinyl-terpyridine.

FIG. 11 is a depiction of a metal-coordinated, supramolecular fluorinated/sulfonated block terpolymer derived from a combination of the polymer in FIG. 9, a block polymer derived from 4′-vinyl-terpyridine, and a block polymer of 2-fluoro-styrene.

FIG. 12 is a depiction of a supramolecular polymer produced by an acid-base reaction between polybenzimidazole (PBI) blended with a block copolymer having sulfonic acid functional groups.

FIG. 13 is a depiction of a method for coating silicotungstic acid (SiWA) using a divinylbenzene monomer, according to one embodiment of the invention.

FIG. 14 is a depiction of a method for coating a heteropolyacid (HPA) using a styrene monomer, according to another embodiment of the invention.

FIG. 15 is a comparison photograph of two composite membranes prepared from polyethersulfone (PES) combined with non-coated (right) and polymer-coated SiWA particles (left).

FIG. 16A is a Nyquist plot showing an electrochemical impedance spectroscopy (EIS) measurement of the conductivity of a composite membrane comprised of 50 wt % PES and 50 wt % phosphotungstic acid (PWA).

FIG. 16B is a Nyquist plot showing an EIS measurement of the conductivity of a composite membrane comprised of 40 wt % PES and 60 wt % phosphotungstic acid (PWA).

FIG. 16C is a Nyquist plot showing an EIS measurement of the conductivity of a composite membrane comprised of 50 wt % PBS and 50 wt % silicotungstic acid (SiWA).

FIG. 16D is Nyquist plot showing an EIS measurement of the conductivity of a 100 wt % PES membrane

FIG. 16E is a Nyquist plot showing an EIS measurement of the conductivity of an acid doped composite membrane of 96.6 wt % polyimide and 3.4 wt % HPA, the composite membrane had been doped with 85% H₃PO₄.

FIG. 17 is a Fourier transform infrared (FTIR) spectrogram of the silicotungstic acid (SiWA) intermediates shown in FIG. 13.

FIG. 18 is a differential scanning calorimetry (DSC) curve showing the glass transition temperature (Tg) of SiWA particles having grafted poly(divinyl benzene).

FIG. 19 is a captured optical microscopy scan showing particle size and particle size distribution of polymer-coated SiWA particles.

FIGS. 20A-C are scanning electron micrographs of (A) SiWA particles, (B) SiWA particles with surface-immobilized 2-(4-chlorosulfonylphenyl)-ethyltrichlorosilane (CTCS), and (C) SiWA particles with grafted poly(divinyl benzene) on the surface of the SiWA particles of (B).

FIGS. 21A-C are x-ray energy dispersive spectrograms of (A) SiWA particles, (B) SiWA particles with surface-immobilized 2-(4-chlorosulfonylphenyl)-ethyltrichlorosilane (CTCS), and (C) SiWA particles with grafted poly(divinyl benzene) on the surface of the SiWA particles of (B).

### DETAILED DESCRIPTION OF EMBODIMENTS OF THE INVENTION

All references cited herein are hereby incorporated by reference to the extent not inconsistent with the disclosure herewith. As used herein and in the appended claims, the singular forms “a”, “an”, and “the” include plural reference unless the context clearly dictates otherwise. As well, the terms “a” (or “an”), “one or more” and “at least one” can be used interchangeably herein. When a Markush group or other grouping is used herein, all individual members of the group and all combinations and sub-combinations possible of the group are intended to be individually included in the disclosure.

As used herein, “comprising” is synonymous with “including”, “having”, “containing” or “characterized by” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods “consisting essentially of” and “consisting of” the recited components or elements. The embodiments of the invention illustratively described herein suitably may be practiced in the absence of any element or elements, limitation or limitations which is not specifically disclosed herein.

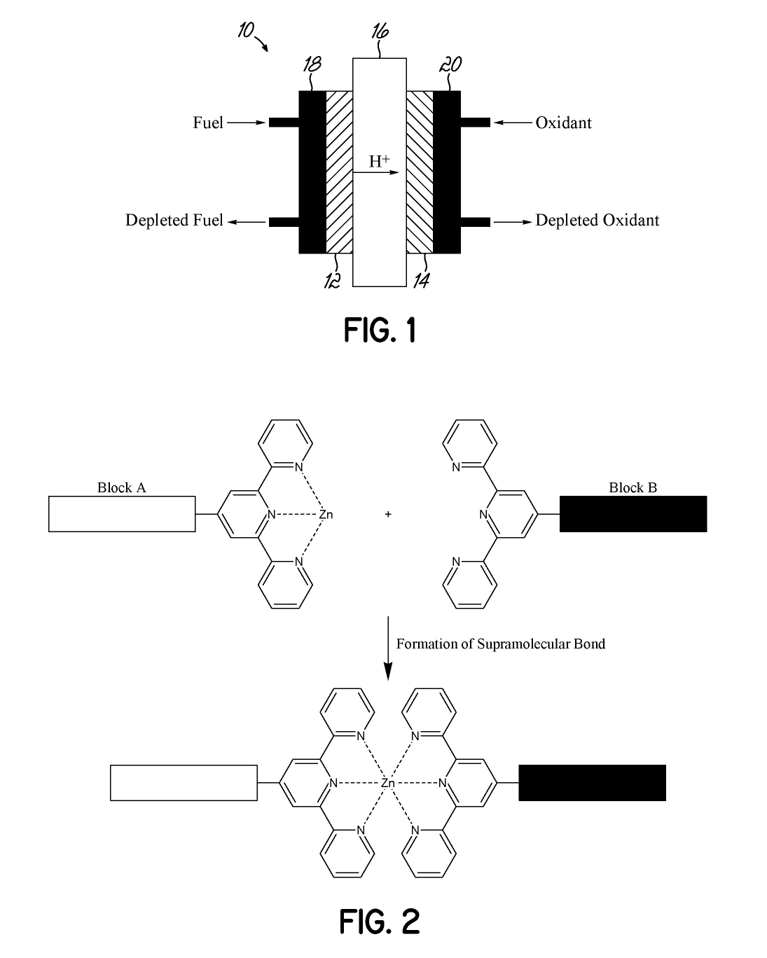

With reference to FIG. 1 and in accordance with an embodiment of the invention, a fuel cell 10 is provided that includes an anode 12, a cathode 14, and a proton exchange membrane 16. The fuel cell 10 further includes a fuel delivery portion 18, which has an inlet for introducing a fuel and an outlet for discharging a depleted fuel, and an oxidant delivery portion 20, which has an inlet for introducing an oxidant and an outlet for discharging a depleted oxidant, as is known in the art. The fuel delivery portion 18 and the oxidant delivery portion 20 provide the fuel and the oxidant to the anode 12 and the cathode 14, respectively.

In one embodiment, the proton exchange membrane 16 has a substrate that includes a polymer, which can define a polymeric layer or film and can be generally nonporous. The polymer can include pendant acid groups and functional groups that are capable of metal coordination. The polymer may further include aromatic heterocyclic groups. In another aspect of the invention, the proton exchange membrane 16 includes a composite material including inorganic proton conducting particles in a polymeric matrix.

The polymeric portion of the proton exchange membrane 16 can include a phase separated morphology. The polymeric portion can include both hydrophobic and hydrophilic regions with the phase separation being due, at least in part, to hydrophilic-hydrophobic interaction. In one example, the hydrophilic acid regions form clusters, layers or aligned channels. Anisotropy and ordering of the regions or channels can also be induced through shearing in the liquid state. As a solvent is evaporated and viscosity rises, supramolecular assemblies can become locked into position and shearing will cease just prior to full solidification. In one example, the shearing is parallel to the substrate (e.g. in the x-y direction) and conductivity perpendicular to the substrate (in the z-direction) is affected. The conductivity perpendicular to film thickness is an important parameter for fuel cell performance. And the formation of submicron channels or domains of ions can result in increased proton conductivity.

According to another embodiment, the polymeric portion of the proton exchange membrane 16 may be a copolymer in which hydrophilic and hydrophobic repeat units are covalently joined. In one example, both the hydrophilic and hydrophobic repeat units contain aromatic heterocyclic groups. In another example, the hydrophilic and/or hydrophobic repeat units contain or are formed from monomers containing a benzimidizole, imide, quinoxaline, or quinoline moiety. In yet another example, the polymeric portion of the proton exchange membrane 16 may be a blend of one or more hydrophilic polymers and one or more hydrophobic polymers.

The polymeric portion of the proton exchange membrane 16 can also include pendant acid groups, which impart proton conductivity. Suitable acid groups include sulfonic acid groups (—SO₃H), phosphonic acid groups (—PO₃H₂), carboxylic acid groups (—CO₂H), and salts thereof.

According to another embodiment, the proton exchange membrane 16 can include a polyetherquinoxaline (PEQ). In one example, the PEQ defines the proton exchange membrane 16. According to another embodiment, the proton exchange membrane 16 can include a polyetherquinoline. In one example, the polyethequinoline defines the proton exchange membrane 16. During synthesis, the polyetherquinoxaline or the polyetherquinoline is formed having repeating units with ether linkages between monomers, with at least one species of monomer being a haloquinoxaline or haloquinoline moiety, respectively, and another being a diol moiety. Representative synthetic approaches to forming the repeating units with ether linkage are provided in Scheme 1 below.

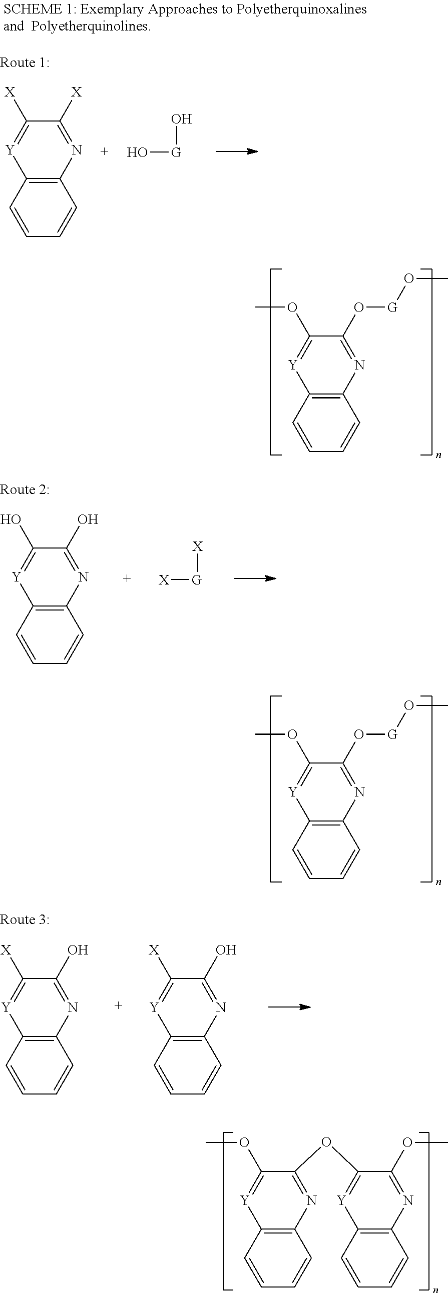

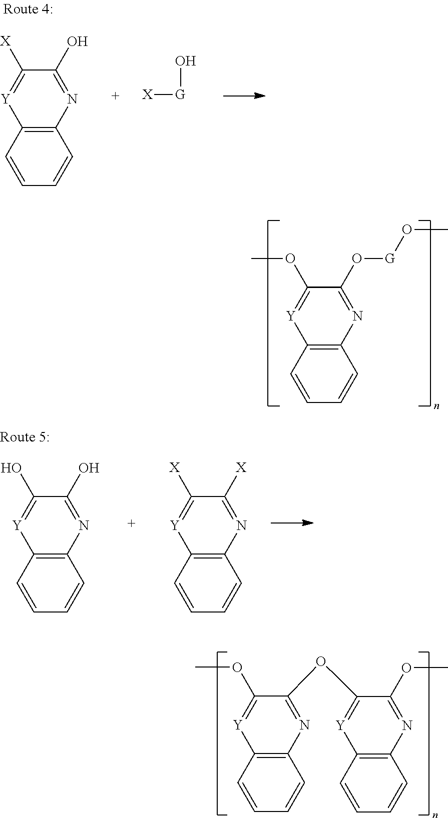

In Scheme 1, Y is nitrogen or a carbon moiety, thereby defining a quinoxaline or a quinoline, respectively; X is a leaving group, such as a halide, which can be displaced by a hydroxyl group or an alkoxyl group to form the ether linkage; G is a generic carbon moiety that may be a substituted or unsubstituted carbon radical, such as an alkyl, an aryl, an alkaryl, an alkenyl, a cycloalkyl, a heteroalkyl, a heteroaryl group; and n is an integer from 25 to 5000. It should be understood that the haloquinoxaline or haloquinoline may be further substituted with functional groups such as, a sulfonic acid group (SO₃H), a phosphonic acid group (PO₃H₂), a carboxylic acid group (CO₂H), salts thereof, and the like.

In one example, X may be the same or different and is a halide selected from the group consisting of chloride, bromide, iodide, and fluoride. In another example, G may be a carbon moiety comprised of 2 or more carbon atoms. For example, G may be a substituted or unsubstituted C₂ to C₂₀ alkyl chain; a substituted or unsubstituted C₂ to C₂₀ aryl group; a substituted or unsubstituted C₂ to C₂₀ alkaryl group; a substituted or unsubstituted C₂ to C₂₀ alkenyl group; a substituted or unsubstituted C₂ to C₂₀ cycloalkyl group; a substituted or unsubstituted C₂ to C₂₀ heteroalkyl group; or a substituted or unsubstituted C₂ to C₂₀ heteroaryl group group. The carbon moiety may be substituted by one or more acid pendant groups selected from the group consisting of a sulfonic acid group (SO₃H), a phosphonic acid group (PO₃H₂), a carboxylic acid group (CO₂H), and salts thereof. In another example, n is an integer within the range of about 25 to about 5000. For example, n may be within the range from about 25 to about 5000. The PEQ or polyetherquinoline polymers may have an average molecular weight within the range from about 10,000 Da to about 200,000 Da.

In one embodiment, as shown in Route 1, a PEQ may be obtained, when Y is nitrogen, from a reaction between a dihaloquinoxaline and a diol. In another embodiment, a PEQ may be obtained from a reaction between a dihydroxyquinoxaline and a dihalide, as shown in Route 2. In another embodiment, a PEQ may be obtained from a homopolymerization reaction of a halohydroxyquinoxaline, as shown in Route 3. In yet another embodiment, a PEQ may be obtained from a reaction between a halohydroxyquinoxaline and a halohydroxy compound, as shown in Route 4. In yet another embodiment, a PEQ may be obtained from a reaction between a dihydroxyquinoxaline and a dihaloquinoxaline, as shown in Route 5. Polyetherquinolines may be similarly prepared as shown in Routes 1-5, where Y is a carbon moiety.

Concerning Route 1, exemplary haloquinoxalines include 2,3-dihaloquinoxaline; 2,6-dihaloquinoxaline; 2,3,6,7-tetrahaloquinoxaline; 2,3-dihalo-6-nitro-quinoxaline; 2,3-dihalo-6-methyl-quinoxaline; and 2,3-bis(halomethyl)quinoxaline. In one example, the dihaloquinoxaline is 2,6-dichloroquinoxaline; 2,7-dichloroquinoxaline; 6,7-dichloroquinoxaline; 2,6-dibromoquinoxaline; 2,3,6,7-tetrachloroquinoxaline; 2,3-dichloro-6-nitro-quinoxaline; 2,3-dichloro-6-methyl-quinoxaline; 2,3-dichloro-6-methoxyquinoxaline; 2,3-dichloro-6,7-dimethylquinoxaline; 2,3-dimethyl-6,7-dichloro-quinoxaline, 2-bromo-7-chloro-quinoxaline, 2-fluoro-6-bromo-quinoxaline, 2-chloro-6-fluoro-quinoxaline, 2-chloro-7-bromo-Quinoxaline, 2-chloro-6,7-difluoroquinoxaline, 2,3-dibromo-6,7-dichloro-quinoxaline, 2-chloro-3-(trifluoromethyl)quinoxaline, or 2,3-bis(bromomethyl)quinoxaline. And exemplary haloquinolines include 2,3-dichloroquinoline; 2,4-dibromoquinoline; 4-iodo-7-chloroquinoline; 2,6-dichloroquinoline; 2,8-dichloroquinoline; 4,7-dichloroquinoline; 2-iodo-3-bromoquinoline; and m-phenyl bisquinoline dibromide. Optionally, the haloquinoxaline or haloquinoline may be substituted by one or more acid pendant groups selected from the group consisting of a sulfonic acid group (SO₃H), a phosphonic acid group (PO₃H₂), a carboxylic acid group (CO₂H), salts thereof, and the like.

Further concerning Route 1, in one embodiment, the diol may be a dihydroxyquinoxaline. Exemplary dihydroxyquinoxalines include 2,3-dihydroxyquinoxaline; 2,3-dihydroxy-6-nitro-quinoxaline; 2,3-dihydroxy-6,7-dimethoxy-quinoxaline; 2,3-dihydroxy-6,7-dichloro-quinoxaline; 2,3-dihydroxy-6,7-dinitro-quinoxaline; 2,3-dihydroxy-6,7-dimethylquinoxaline; 2,3-dihydroxy-6-methoxyquinoxaline; or 2-hydroxy-3-carboxyquinoxaline. According to another embodiment, the diol may be a dihydroxyquinoline. Exemplary dihydroxyquinolines include 2,3-dihydroxyquinoline; 2,4-dihydroxyquinoline; 2,6-dihydroxyquinoline; 2,8-dihydroxyquinoline; 4-carboxy-2-hydroxyquinoline; 2-carboxy-8-hydroxyquinoline; 2-carboxy-4-hydroxyquinoline; 2-carboxy-4,8-dihydroxyquinoline; 5-[[4-(2-hydroxyethyl)-1-piperazinyl]methyl]-8-quinolinol; N-butyl-2,2′-imino-bis(8-hydroxyquinoline); 2,3-bis(4-hydroxyphenyl)quinoxaline-6-carboxylic acid; and 2,3-bis(3-amino-4-hydroxyphenyl)quinoxaline-6-carboxylic acid dihydrochloride.

According to another embodiment, the diol may include at least one hydroxyl group directly bonded to an aromatic ring. In another embodiment, the diol may include at least two hydroxyl groups, with each of the at least two hydroxyl groups being directly bonded to the same or a different aromatic ring. The diol may also include at least one hydroxyl group directly bonded to a saturated carbon. In yet, another embodiment, the diol may include at least two hydroxyl groups, with each of the at least two hydroxyl groups being directly bonded to a saturated carbon.

Exemplary diols include, 1,1′-(4,6-dihydroxy-1,3-phenylene)bisethanone; 1,4-dihydroxy-2-naphthoic acid; 2,2′-dihydroxy-1,1′-azonaphthalene-3,3′,6,6′-tetrasulfonic acid; 2,4-dihydroxy-5,6-dimethylpyrimidine; 3,6-dihydroxy-4-methylpyridazine; 4,7-dihydroxy-1,10-phenanthroline; 5,8-dihydroxy-1,4-naphthoquinone; 6,8-dihydroxy-1,3-pyrenedisulfonic acid disodium salt; 4,5-dihydroxy-1,3-benzenedisulfonic acid disodium salt monohydrate; 4-nitrocatechol; 4-ethylresorcinol; 3-methoxycatechol; croconic acid; dithranol; 2-thiobarbituric acid; 1,6-dihydroxynaphthalene; 2,2′,3,3′,5,5′,6,6′-octafluoro-4,4′-biphenol hydrate; 2,2′-biphenyldimethanol; 4,4′-(9-fluorenylidene)diphenol; 4,4′-(hexafluoroisopropylidene)diphenol; 2,3-dihydroxynaphthalene-6-sulfonic acid, sodium salt; 2,2-dihydroxy-5-methoxy-1,3-indandione hydrate; 2,3,5,6-tetramethyl-p-xylene-α,α′-diol; 2,3-dichloro-5,8-dihydroxy-1,4-naphthoquinone; 2,5-dibromohydroquinone; 2-nitroresorcinol; 3,6-dihydroxynaphthalene-2,7-disulfonic acid disodium salt; 4,4′-dihydroxybenzophenone; 4,4′-isopropylidenedicyclohexanol (mixture of isomers); 5-chloro-2,3-pyridinediol; 2,2′-biphenol; 4,4′-(1,3-phenylenediisopropylidene)-bisphenol; 4,4′-(1-phenylethylidene)bisphenol; 4,4′-cyclohexylidenebisphenol; 4,4′-ethylidenebisphenol; 4,4′-dihydroxybiphenyl; 4,4′-sulfonylbis(2-methylphenol); 4,4′-sulfonyldiphenol; bisphenol A; bisphenol C, cis-2-butene-1,4-diol, or trans-2-butene-1,4-diol.

In another embodiment, as shown in Routes 2 and 5 of Scheme 1 above, a PEQ may be formed from a reaction between a dihydroxyquinoxaline and a dihalide. Suitable dihalides include 2,3-bis(bromomethyl)quinoxaline and 2,6-dichloroquinoxaline; 4,4′-difluoro-benzophenone; 4,4′-dichloro-3,3′-dinitrobenzophenone; 4,4′-dibromobenzophenone; 4,4′-dichlorobenzophenone; 3,3′-difluorobenzophenone; 1,5-dichloroanthraquinone; 4,4′-dibromobenzil; bis(4-fluorophenyl)phenylphosphine oxide; 2,3-dichloromaleic anhydride; 3,6-difluorophthalic anhydride; 3,6-dichlorophthalic anhydride; and 4,5-dichlorophthalic anhydride.

Exemplary dihydroxyquinoxalines include 2,3-dihydroxyquinoxaline; 2,3-dihydroxy-6-nitro-quinoxaline; 2,3-dihydroxy-6,7-dimethoxy-quinoxaline; and 2-hydroxy-3-carboxyquinoxaline. Polyetherquinolines may be similarly prepared from dihydroxyquinolines and dihalides.

In yet another embodiment, PEQs may be derived from a halohydroxyquinoxaline, via homo-polymerization as shown in Route 3, or from a reaction product of the halohydroxyquinoxaline and a halohydroxy compound, as shown in Route 4. Polyetherquinolines may be similarly prepared from halohydroxyquinolines. Exemplary halohydroxy compounds include, 2-chloro-3-hydroxyquinoxaline and 2-chloro-3-(2-hydroxyethylamino)quinoxaline; 2,3-dichloro-5,8-dihydroxy-1,4-naphthoquinone; 2,5-dibromobenzene-1,4-diol; bisphenol C; 8-chloro-2-hydroxyquinoline; 6-chloro-2-hydroxyquinoline; 7-chloro-4-hydroxyquinoline; 5-chloro-8-hydroxyquinoline; 2-halo-3-hydroxyquinoline; 5,7-dibromo-8-hydroxyquinoline; 5-chloro-8-hydroxy-7-iodoquinoline; 5,7-diiodo-8-hydroxyquinoline; 5,7-dichloro-8-hydroxyquinoline; 5-chloro-8-hydroxyquinoline; 7-chloro-4-hydroxyquinoline; 6-chloro-2-hydroquinoline; 8-chloro-2-hydroxyquinoline; and 8-fluoro-4-hydroxyquinoline.

The formation of the ether linkage by the displacement of a halide with a hydroxyl or a hydroxide group may be facilitated by the presence of a suitable base, such as potassium carbonate, sodium carbonate, tri-sodium phosphate, and tri-potassium phosphate, in one or more solvents, such as N,N-dimethylformamide (DMF), N,N-dimethylacetamide (DMAc), 1-methyl-2-pyrollidinone (NMP), N-octyl pyrrolidone, dimethylsulfoxide (DMSO), sulfolane, hexamethylphosphoramide (HMPA), toluene, m-cresol and the like. To increase the rate of reaction, the reaction mixture may be heated at about room temperature up to about 200° C. In one example, the temperature is from about 100° C. to about 200° C. Other additives, including drying agents, such as molecular sieves, may also be included in the reaction mixture.

The polyetherquinoxalines and polyetherquinolines may be isolated and purified using common techniques practiced by those commonly skilled in the art. The polyetherquinoxalines and polyetherquinolines also may be used alone or in combination with other commonly-used materials to form a substrate for preparing proton exchange membranes 16. As such, the proton exchange membrane 16 can be prepared from substrates including polyetherquinoxalines and/or polyetherquinolines.

According to another embodiment of the invention, the proton exchange membrane 16 may be formed by self-assembly through interaction of metal-coordination functional groups with metal ions. FIG. 2 schematically illustrates use of a zinc-coordinated terpyridine linkage to link two “blocks”. The traditional thinking about organometallic polymers is that they will not work well as proton exchange membranes because the presence of the metal center will inhibit proton transport. In one embodiment, the proton exchange membrane 16 includes metal ions at one stage in the fabrication process, but the metal centers will be removed after the polymer is fully cross-linked, leaving a metal organic framework (MOF). This can provide an “anion hole” from the remaining bipyridine or terpyridine linkage, which may serve as a proton conductor. This procedure can provide permanent electronic channels for facilitated proton transport and thus increased proton conductivity.

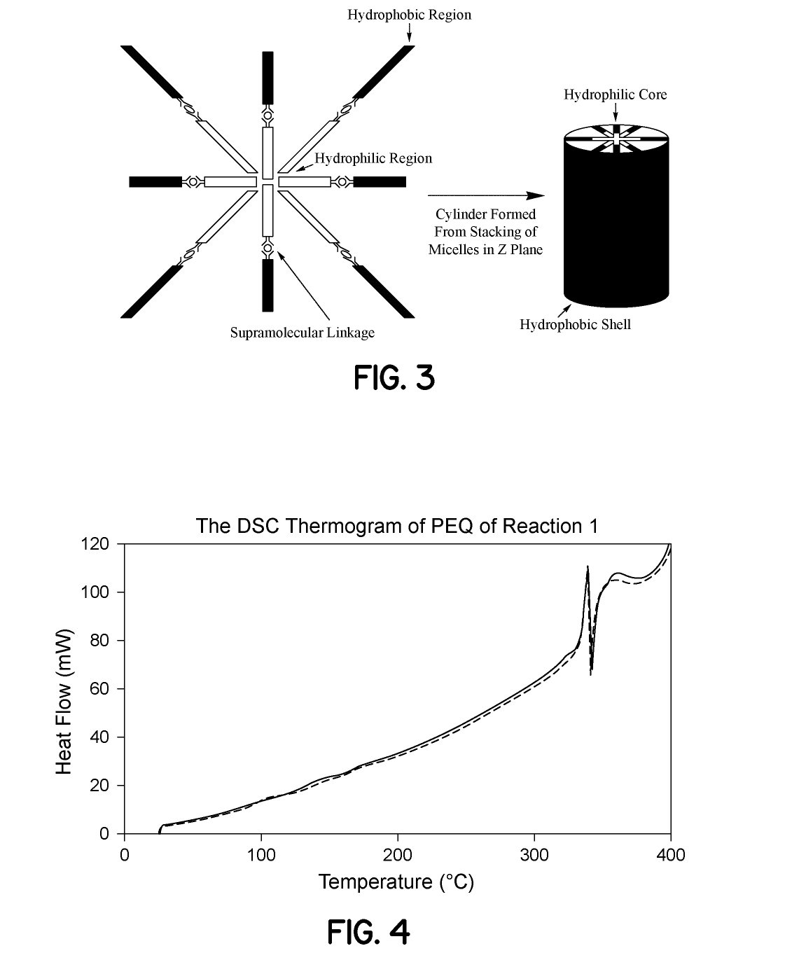

FIG. 3 illustrates a method of forming a hydrophilic channel using metal-coordinated assembly of hydrophilic and hydrophobic blocks. In one embodiment, the polymeric portion of the proton exchange membrane 16 includes hydrophilic and hydrophobic blocks that are joined through metal-coordination interactions, as schematically illustrated in FIG. 2. Assembly of the polymer blocks in this fashion can allow better control of the block size than with traditional free radical polymerization approaches. It is believed that the hydrophilic regions of the polymer will overlap, providing self assembly to form nano-structured systems.

In another embodiment, the polymeric portion of the proton exchange membrane 16 is a copolymer in which hydrophilic and hydrophobic repeat units are covalently joined and which has pendant functionalities that are capable of metal coordination. These functionalities can be used to form metal-coordinated cross-links between polymer chains.

In another embodiment, the polymeric portion of the proton exchange membrane 16 includes a polymer backbone with pendant acid groups and pendant functional groups which are capable of metal coordination. The polymer will generally have hydrophobic and hydrophilic portions, but these need not be limited to a particular copolymer block.

In another embodiment, the polymeric portion of the proton exchange membrane 16 is a blend of a hydrophilic polymer and a hydrophobic polymer, both polymers having metal coordination functional groups.

Functional groups useful for metal coordination include bipyridyl units or terpyridine units. In one example, the polymeric portion of the proton exchange membrane 16 includes bipyridal or terpyridine polymeric units which are capable of coordination with a metal ion. Suitable metallic ions include ruthenium, zinc, copper, cobalt, and iron. In different embodiments, the metal ion may be a zinc ion or a ruthenium ion. In another embodiment, the polymer contains multiple metal ligands. Terpyridine ligands are useful because of the outstanding complexing abilities of these units. In another embodiment, the polymer unit includes a bipyridine unit such as 2,2′-bipyridine. In different embodiments, the polymer unit contains polyimide or polybenzimidazole segments.

Bypyridyl moieties suitable for synthesizing the polymer potion of the proton exchange membrane 16 include, for example, 2,2′-bipyridine-3,3′-diol; 2,2′-bipyridine-4,4′-dicarboxaldehyde; 2,2′-bipyridine-4,4′-dicarboxylic acid; 2,2′-bipyridine-3,3′-dicarboxylic acid; 2,2′-bipyridine-5,5′-dicarboxylic acid; and 4-4′-dimethoxy-2-2′-bipyridine. Terpyridyl moieties suitable for synthesizing the polymer potion of the proton exchange membrane 16 include, for example, 6,6″-dibromo-2,2′:6′,2′-terpyridine; 4′-chloro-2,2′:6′,2″-terpyridine; 4′-(4-chlorophenyl)-2,2′:6,2′-terpyridine; trimethyl 2,2′:6′,2′-terpyridine-4,4′,4′-tricarboxylate; and trimethyl 2,2′:6′,2″-terpyridine-4,4′,4″-tricarboxylate.

If desired, the metal center can be removed by reacting the fully polymerized metal organic framework in an acidified solution. After removal of the metal center, the counter ions can be reacted with a salt to stabilize the structure. Suitable salts include, but are not limited to sodium chloride, sodium sulfate, sodium phosphate, and sodium nitrate.

In another embodiment of the invention, the proton exchange membrane 16 includes an inorganic proton conductor, so that the proton exchange membrane 16 is a composite of inorganic proton conducting particles in a polymeric matrix. In one example, this inorganic proton conductor is a solid acid. In another example, the inorganic proton conductor is a heteropolyacid (HPA). Suitable heteropolyacids include, but are not limited to phosphotungstic acid (PWA), silicotungstic acid (SiWA), phosphomolybdic acid (PMoA), silicomolybdic acid (SiMoA) and combinations thereof. The HPAs may be in particulate form. The particle size of the HPAs can be from 1 to 10 microns or 1 to 5 microns. In another example, the particle size is approximately 3 microns. The weight fraction of the HPAs can be from about 5 to about 80%. The desired weight percentage of inorganic proton conductor may depend on the proton conductivity of the polymeric matrix material.

In another embodiment, the surface of the inorganic proton conductor is polymer-coated before it is combined with the matrix material. The polymer coating can help integrate the inorganic proton conductor into the polymer matrix and/or can help protect against environmental degradation of the inorganic proton conductor. The coating can be applied via a surface polymerization technique. Surface polymerization methods include: atom transfer radical polymerization (ATRP), ring opening metathesis polymerization (ROMP), radical addition fragment transfer (RAFT), and click chemistry (CC). When the monomers are polymerized from a surface-bound initiating moiety using these techniques, the resulting polymer coating structure is controllable.

Exemplary monomers for surface coating an inorganic proton conductor include 3-sulfopropyl acrylate potassium salt; 2-acrylamido-2-methyl-1-propanesulfonic acid; 2-acrylamido-2-methyl-1-propanesulfonic acid sodium salt; 3-allyloxy-2-hydroxy-1-propanesulfonic acid sodium salt; allylphosphonic acid monoammonium salt; vinylphosphonic acid; vinylsulfonic acid sodium salt; 2-methyl-2-propene-1-sulfonic acid sodium salt; and sodium 4-vinylbenzenesulfonate.

Monomers suitable for use with surface polymerization techniques include, but are not limited to, fluorinated acrylates (e.g.: 2,2,3,4,4,4-hexafluorobutyl acrylate, 4,4,5,5,6,6,7,7,8,8,9,9,10,11,11,11-hexadecafluoro-2-hydroxy-10-(trifluoromethyl)undecyl methacrylate, and 2,2,3,3-tetrafluoropropyl acrylate), styrenic monomers (e.g., 2-vinylnaphthalene, styrene, 4-acetoxystyrene, 4-tert-butylstyrene, 3,4-dimethoxystyrene, 4-tert-butoxystyrene, 2,4-dimethylstyrene, 2,5-dimethylstyrene, 4-ethoxystyrene, 3-methylstyrene, 2,4,6-trimethylstyrene, 4-vinylaniline, and 4-vinylanisole), and fluorinated or partially-fluorinated styrene (e.g., 2,6-difluorostyrene, 2-fluorostyrene, 3-fluorostyrene, 4-fluoro styrene, 2,3,4,5,6-pentafluorostyrene, 2-(trifluoromethyl)styrene, and 3-(trifluoromethyl)styrene, 4-(trifluoromethyl)styrene). In one example, the monomer is styrene. In another example, the monomer is a partially-fluorinated styrene, such as 2,6-difluorostyrene, 2-fluorostyrene, or 3-fluorostyrene. In yet another example, the monomer is a fluorinated acrylate, such as 4,4,5,5,6,6,7,7,8,8,9,9,9-tridecafluoro-2-hydroxynonyl acrylate; 4,4,5,5,6,7,7,7-octafluoro-2-hydroxy-6-(trifluoromethyl)heptyl acrylate; 4,4,5,5,6,7,7,7-octafluoro-2-hydroxy-6-(trifluoromethyl)heptyl methacrylate; or 4,5,5,6,6,7,7,8,8,9,9,10,10,11,11,11-heptadecafluoro-2-hydroxyundecyl acrylate. In still another example, the monomer is divinylbenzene.

A monomer used for formation of the polymer coating may contain an acid functional group, such as a sulfonic acid group. In another example, the surface-bound polymer may be acid treated (e.g., sulfonated) after formation. Suitable acid groups include sulfonic acid groups (SO₃H), phosphonic acid groups (PO₃H₂), carboxylic acid groups (CO₂H), and salts thereof.

Atom transfer radical polymerization (ATRP) has the following features: The polymerization can be performed at very mild conditions (room temperature), with high yield and on a broad range of monomers. The occurrence of transfer reactions (in solution) is negligible, because the radical species are always present at the end of the growing, surface tethered polymer chains. In this polymerization, radicals are generated by the redox reaction of alkyl halides with transition-metal complexes. Radicals can then propagate but are rapidly deactivated by the oxidized form of the transition-metal catalyst. Initiators typically used are α-haloesters (e.g., ethyl 2-bromoisobutyrate and methyl 2-bromopropionate) or benzyl halide (e.g., 1-phenylethyl bromide and benzyl bromide). A wide range of transition—metal complexes such as Ru—, Cu— and Fe-based system have been successfully applied to ATRP. For Cu-based systems, ligands, such as 2,2′-bipyridine and aliphatic amines, have been employed to tune both solubility and activity of various ATRP catalysts.

ATRP has been successfully applied for the controlled polymerization of styrene, methacrylate, methacrylamides, acrylonitrile and 4-vinylpyridine. For example, graft polymerization of methyl methacrylate (MMA) by ATPR on an initiator-immobilized substrate has been demonstrated. (Ejaz, M., et al., Macromolecules (1998), 31, 5934-5936). The initiator used was 2-(4-chlorosulfonyphenyl)ethyl trimethoxysilane, which can be immobilized on oxidized silicon particles. In another example, a cross-linked ultra-thin polymer film coating on gold was synthesized, using ATRP, (Huang, W., et al., Angew, Chem. Int. Ed., 2001, 40 No. 8, 1510-1512). The disulfide initiator was immobilized onto the gold surface followed by surface grafting polymerization by the ATRP approach. Cross-linking is provided by multifunctional ethylene glycol dimethacrylate.

Ring opening metathesis polymerization (ROMP) catalyzed by well-defined metal-alkylidines has proven to be an efficient method to control polymer molecular structure, size, and bulk properties. Ruthenium-based ROMP initiators have been shown to polymerize a large variety of monomers in a living fashion in a number of solvents, ranging from benzene to water. With these advances in catalyst design, ROMP is capable of overcoming the obstacles, such as side reactions and impurities on a surface, for surface polymerization.

Kim, et al., developed a method for growing thin polymer films from the surface of a silicon substrate by ring-open metathesis polymerization. (Kim, N.Y., et al. Macromolecules (2000), 33, 2793-2795). There is a three step procedure. First, there is formation of a self-assembled monolayer (SAM) on silicon that incorporates norbornenyl groups. Second, there is attachment of a ruthenium catalyst to the surface using the norbornenyl groups. And third, the polymerization of added monomer to generate the film. This reaction offers ease of use and control over the thickness and chemical composition of deposited film. Watson, et al. took advantage of the functional-group-tolerant ruthenium carbene catalysts. The initiator was immobilized to the surface of gold nanoparticles and the living polymerization carried out on the surface of the particles. The advantages of this strategy are numerous including: control over polymer length and chemical composition as well as particles size, solubility and shape. (Watson, K. J., et al. J. Am. Chem. Soc. (1999), 121, 462-463).

In another embodiment, the surface of the inorganic particle may be modified with an acid-terminated silane molecule. Surface modification with acid-terminated silane molecules can have the following advantages: strong bonding between the silane molecules and the particle surface, improved compatibility between the particles and the polymer matrix, and increased proton conductivity of the composite. Suitable acid groups include sulfonic acid groups (SO₃H), phosphonic acid groups (PO₃H₂), carboxylic acid groups (CO₂H), and salts thereof. In one example, the silane is sulfonic acid terminated. In different embodiments, the silicon atom of the silane molecule is bound to at least one hydroxyl, alkoxyl, halogen or SH group. In another example, the silicon atom is attached to one or more hydroxyl groups. The acid group and silicon atom may be linked by an alkyl chain. The number of carbon atoms in the alkyl chain may be from 3 to 20 or from 3 to 10. Suitable sulfonic acid terminated silanes, include, but are not limited to, 3-(trihydroxysilyl)-1-propanesulfonic acid (TDSPA). In one embodiment, the acid-terminated silane molecule is used to modify HPA particles.

The composite membrane may be formed by mixing the HPA particles (coated, uncoated, or a combination thereof) with a polymer precursor, casting the resulting mixture on a substrate, and then polymerizing the precursor. According to one embodiment, any solvents used in the processing do not dissolve the HPA. These solvents include, but are not limited to, THF and toluene. The controlled hydrophobic/hydrophilic regions of the nano-structured membrane can be bridged by the HPA nanoparticles. It is believed that this bridging effect can further decrease the hopping resistance between HPA particles. The incorporation of HPAs into the proton exchange membrane 16 is also expected to affect the crystallinity of the structure.

In addition to the polyetherquinoxalines described above, a wide variety of polymer matrices may be used for a composite membrane, including polymers known for use in proton exchange membranes. For example, commercially available polymers that are suitable for use in embodiments of the present invention include Nafion® (Dupont), BAM™ ionomer (Ballard Power Systems), sulfonated-styrene ethylene butylenes styrene (SEBS) (Dias Analytical), polyvinylidene fluoride (PVDF) (Kynar, Arkema), polyethersulfone (PES) (Solvay), UDEL® (Solvay), Victrex® PEEK™ (Victrex), and polybenzimidazole (PBI) (BASF, Celazole).

Other non-commercially available polymers, which have been synthesized for PEM, are suitable for use in embodiments of the present invention and include poly(2,6-dimethyl-1,4-phenylene oxide) (PPO) blend with poly(styrene-b-vinylbenzylphosphonic acids) (PS-b-VBPA), see Journal of Membrane Science 308 (2008) 96-106; sulfonated PPO(SPPO) with PBI blended membranes, see Electrochimica Acta, 52 (2007) 8133-8137; polyp-xylene tetrahydro-thiophenium chloride) (PPV precursor) and Nafion® composite membranes, see Journal of Membrane Science 304 (2007) 60-64; poly(arylenethioether)sulfone synthesized and used as PEM after sulfonation, see Polymer, Volume 48, Issue 22, 19 Oct. 2007, Pages 6598-6604; polyether sulfone blend with sulfonated polyamide, see J. Phys. Chem. B 2008, 112, 4270-4275; poly(sulfide ketones)—ionomers with sulfonic acid group attached to the end group, see Macromolecules 2008, 41, 277-280; composite membrane with zirconium phosphate and Nafion®, see Macromolecules 2007, 40, 8259-8264; and sulfonated poly(arylene-co-naphthalimides), see Macromolecules 2006, 39, 6425-6432. Further examples include those disclosed in Chem. Rev. 2004, 104, 4587-4612, including a class of copolymer that includes a styrenic main chain and sodium styrenesulfonate graft chains (PS-g-macPSSNa); sodium styrenesulfonate macromonomers as grafts to poly-(acrylonitrile) backbone chains; poly(styrene sulfonic acid) grafts have also been attached to poly(ethylene-co-tetrafluoroethylene) (ETFE) and poly(vinylidene fluoride) (PVDF); directly copolymerized sulfonated poly(arylene ether ketone) PEMs by employing a sulfonated dihalide ketone monomer (sodium 5,5′-carbonylbis(2-fluorobenzenesulfonate)); copolymers based on hexafluoroisopropylidene bisphenol (6F); additional functionality to the poly(arylene ether) by the copolymerization of 2,6-dichlorobenzonitrile, hexafluoroisopropylidene bisphenol (6F), and 3,3′-disulfonate-4,4′-dichlorodiphenyl sulfone; poly(4-phenoxybenzoyl-1,4-phenylene) (PPRP) was sulfonated; sulfonated poly(4-substituted benzoyl-1,4-phenylene) homopolymers; sulfonated polyphenylenes, multiblock copolymers from reacting a more flexible poly(arylene ether sulfone) with sulfonated polyphenylenes; soluble copolyarylenes via a Ni(0)-catalyzed coupling reaction of aryl chlorides; and poly(phthalazinone ether ketone)s (PPEKs).

Additional monomers containing sulfonic acid or carboxylic acid groups that can be suitable for use in forming a polymer matrix include, for example, 4,4′-diaminodiphenyl ether-2,2′-disulfonic acid (ODADS); 9,9′-bis(4-aminophenyl)fluorene-2,7-disulfonic acid (BAPFDS); 4,4′-bis(4-aminophenoxy)biphenyl-3,3′-disulfonic acid (BAPBDS); 4,4′-bis(4-aminophenoxy)biphenyl-3,3′-disulfonic acid (mBAPBDS); 4,4′-bis(4-amino-2-sulfophenoxy)biphenyl (iBAPBDS), as disclosed by Fang, J. et. al., Journal of Power Source, Vol. 159, pp. 4-11, 2006. Other monomers include, 1,4-bis(4-amino-2-sulfonic acid-phenoxy)-benzene (DSBAPB), as disclosed by Shang, Y., et. al., European Polymer Journal, Vol 42, pp. 2987-2993, 2006; and Benzofuro[2,3-b]-benzofuran-2,9-dicarboxylic acid and Benzofuro[2,3-b]-benzofuran-2,9-dicarboxyl-nis-phenylamide-4,4′-dicarboxylc acid, as disclosed by Banihashemi, A., et. al., European Polymer Journal, Vol. 38, pp. 2119-2124, 2002.

According to another embodiment, the polymer matrix is a supramolecular polymer. In another embodiment, the polymer matrix is a polyimide. In another embodiment, the polymer matrix is based on polyethersulfone, polyquinoxaline or polyquinoline. The monomers comprising dihydroxy, dihalo, bipyridyl, and/or terpyridyl funtionality, as discussed above, are useful for the formation of supramolecular PEM materials that are based on polyethersulfone, polyquinoxaline and polyquinoline.

Supramolecular PEM Based on Polyethersulfone:

Polyether sulfones (PES) are important and well-known in engineering thermoplastics. This class of polymers displays excellent thermal and mechanical properties, as well as resistance to oxidation and catalyzed hydrolysis. The polyethersulfones have high glass transition temperature because of the high strength of sulfone group present. The ether linkages provide flexibility to the polymer and thus, make polyether sulfones easily processable. The reaction typically is between a dihydroxy containing molecule and a dihalide molecule.

Supramolecular polymers offer a unique route to the formation of highly directional and nano-structured materials. These structures possess unique morphology and are expected to allow the formation of submicron channels or domains which will increase the proton conductivity. PEMs have been synthesized using a sulfonated copolymer of 4-vinylpyridine and styrene which allows proton transfer from a sulfonic acid group to a nitrogen heterocycle. It was also demonstrated that heterogeneous systems of conductive and nonconductive phases could be oriented to produce anisotropy in the direction of proton conduction. Using shear flow large scale orientation was achieved and proton conductivity was 2.5 times higher in-plane. This work in conjunction with the work on nano-channels, which has been working on nano-channel-base fuel cell, suggests the possibility of achieving large scale proton conductivity in orientated pores and channels because of the limitation power output in one-dimension array configuration.

The reaction of polyether polymer typically is between a dihydroxy (—OH) containing molecule and a dihalide (e.g.: F, Br, etc.) molecule. The supramolecular interaction can be achieved by incorporating terpyridine or bipyridine coordinated with metal ions (e.g.: Zn, Ru, etc.). Examples of supramolecular PEM based on polyethersulfone (PES) are shown below in Scheme 2 and 3, wherein X and/or Y are integers independently within the range of about 25 to about 5000. For example, X and/or Y may be within the range from about 50 to about 4000.

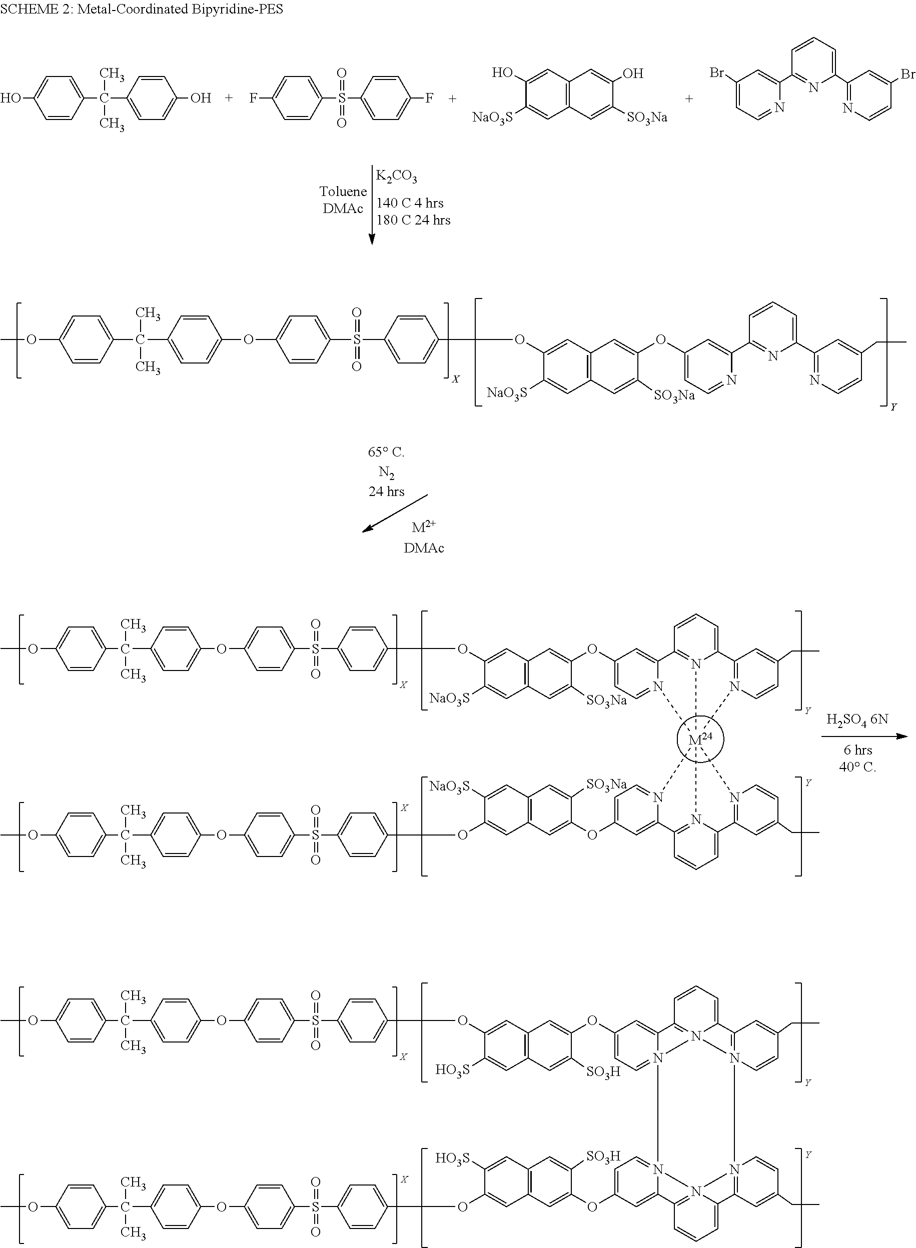

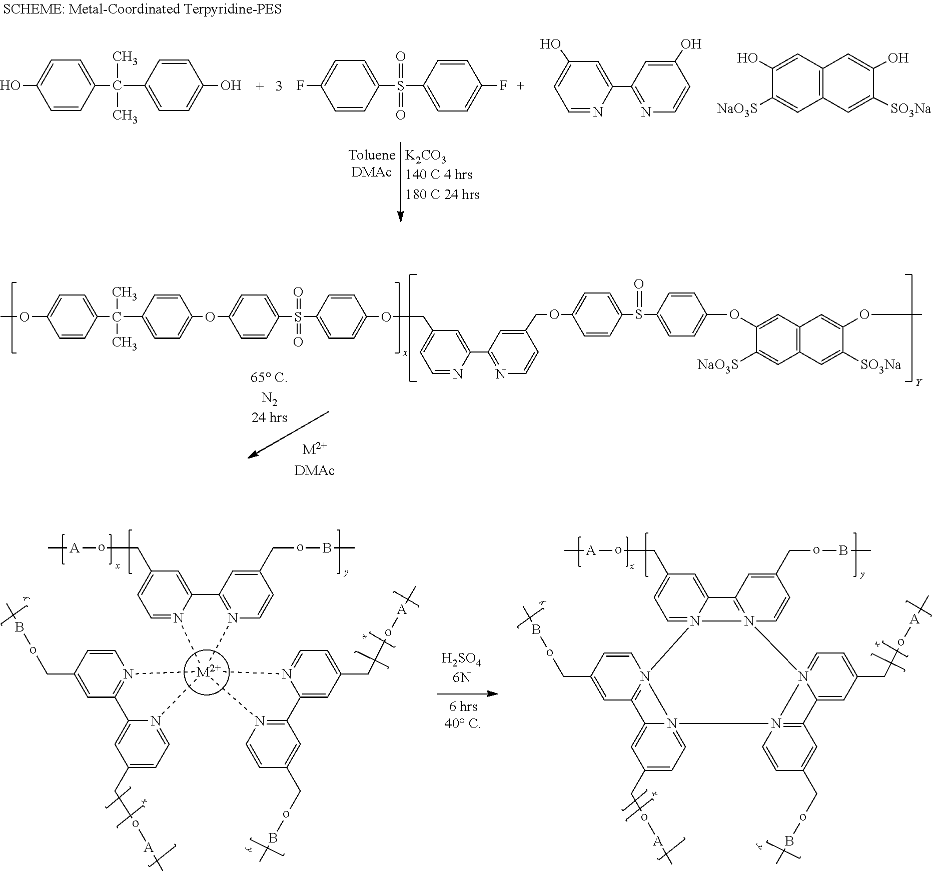

Supramolecular interactions with polyquinoxaline and polyquinoline can be achieved through addition of a fluorinated amphiphile, and metal-coordinated terpyridine or bipyridine. Examples of supramolecular PEM based on polyquinoxaline and polyquinoline are shown below in Schemes 4-8, wherein X, Y, n and/or m are integers independently within the range of about 25 to about 5000. For example, X, Y, n and/or m may be within the range from about 50 to about 4000.

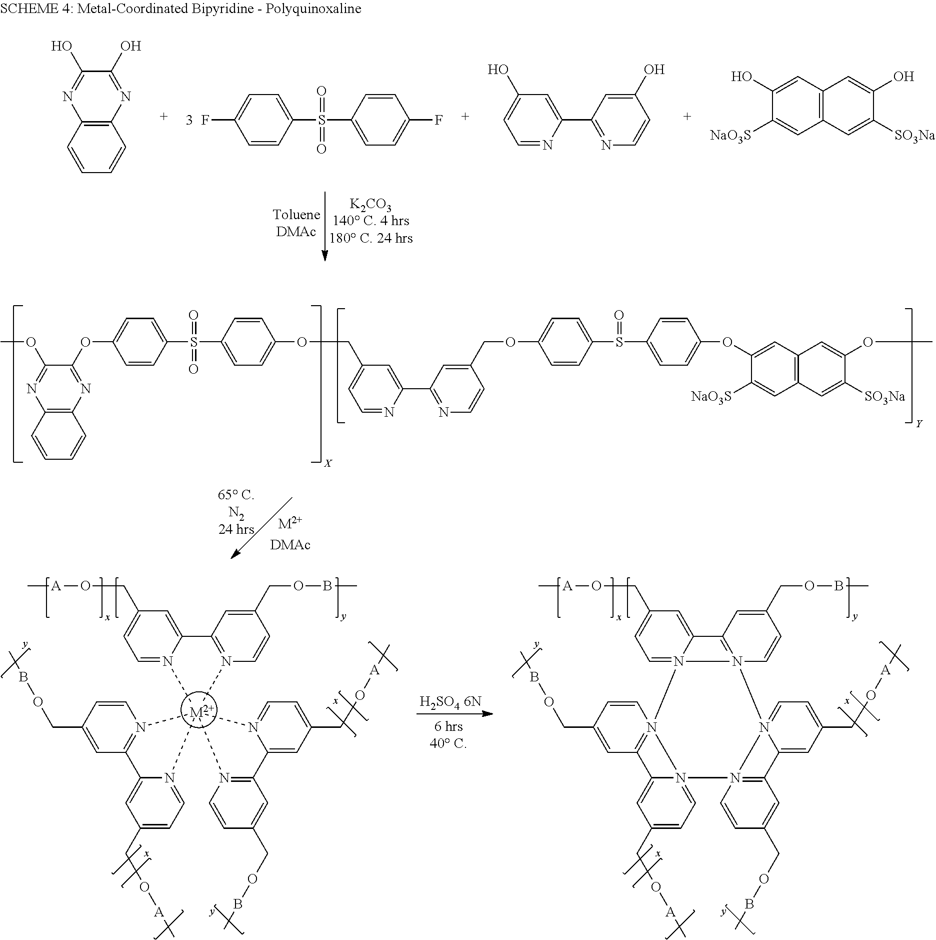

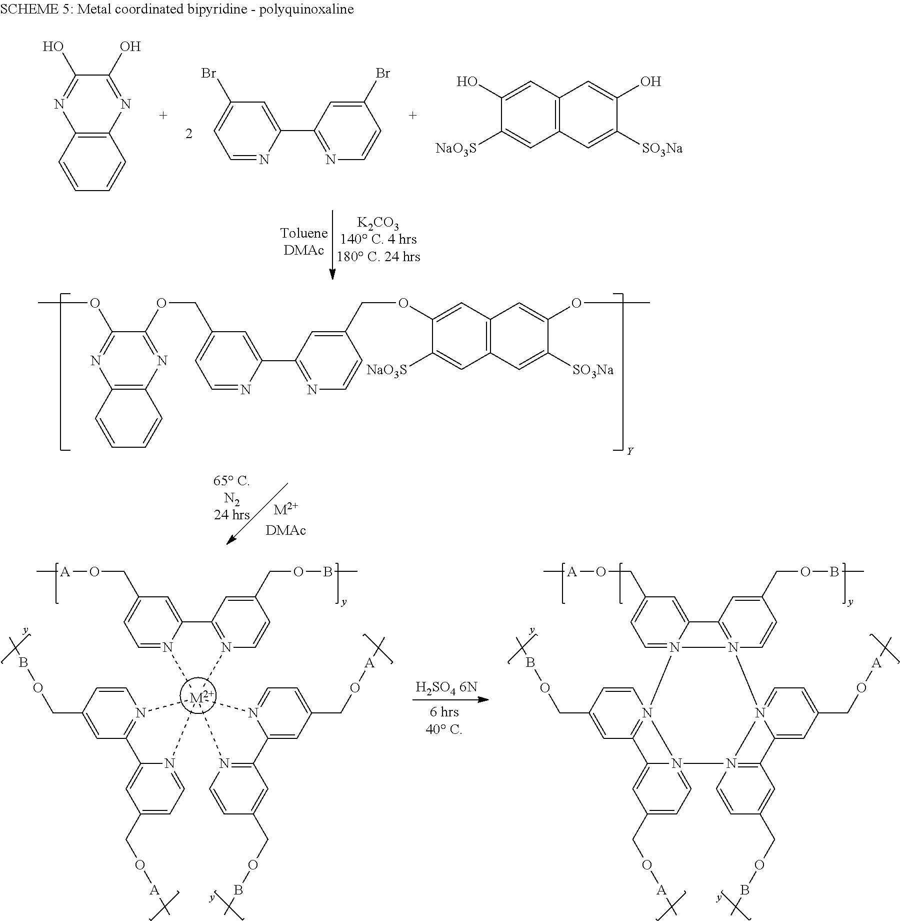

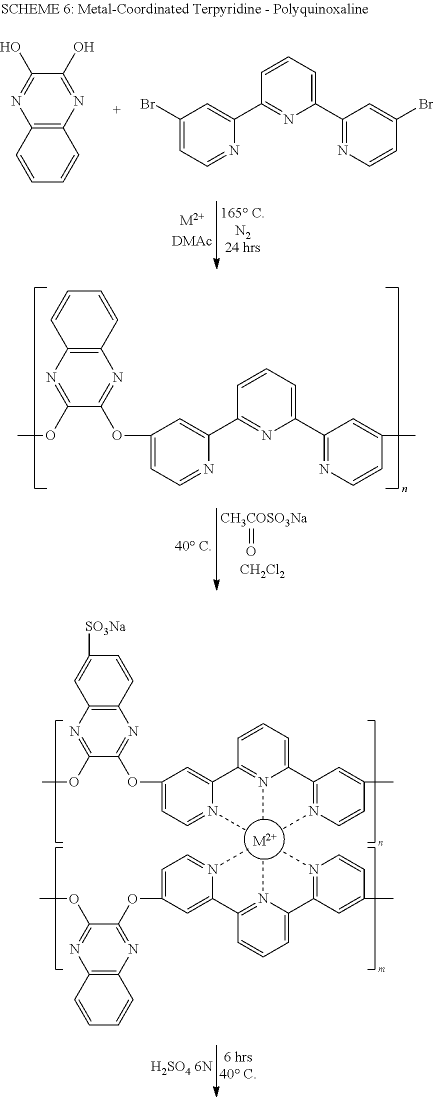

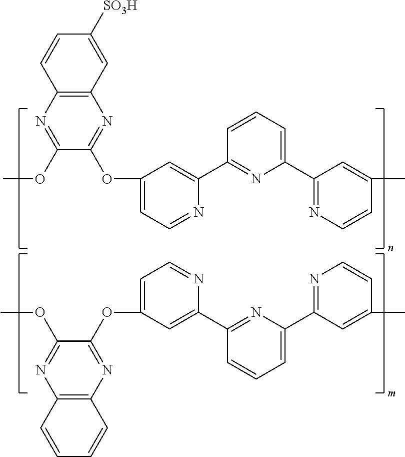

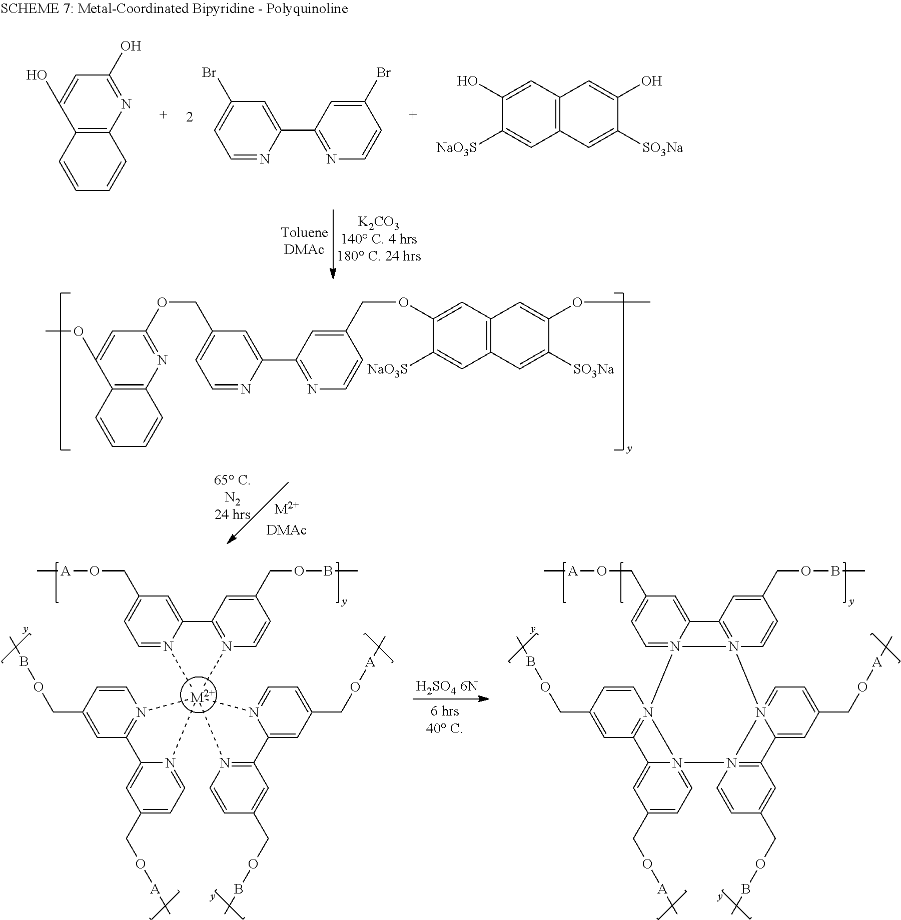

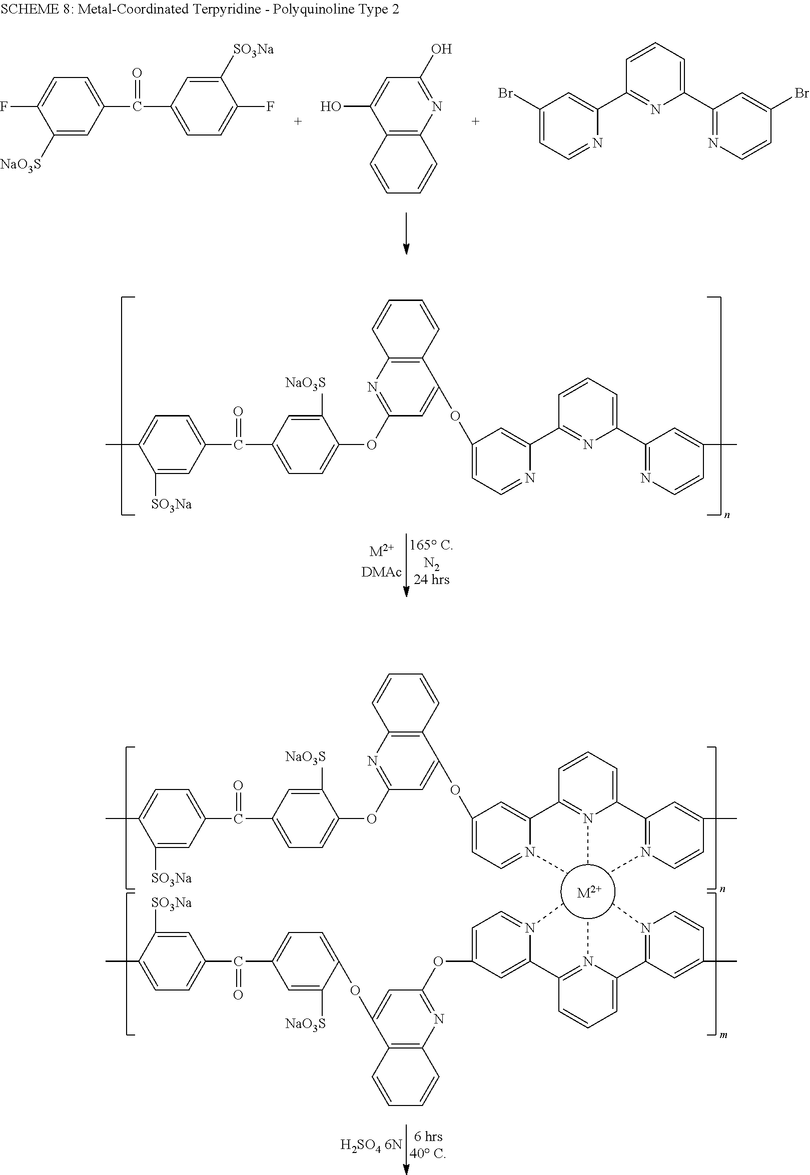

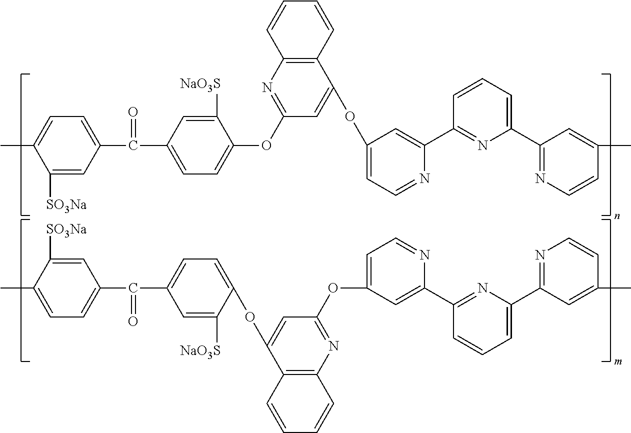

An amphiphile, such as fluorhexadecylbenzoate, can be used to create hydrophobic/hydrophilic interactions with the polyquinoline. The supramolecular interaction of fluorinated surfactant with backbone polyquinoline is shown in the scheme below. The hydrophobic interactions take place between the fluorinated part of the amphiphile and the fluorinated diphenyl segment. The hydrophilic interactions involve hydrogen bonding between the sulfonic acid group on the polymer and the carboxylic acid on the amphiphile.

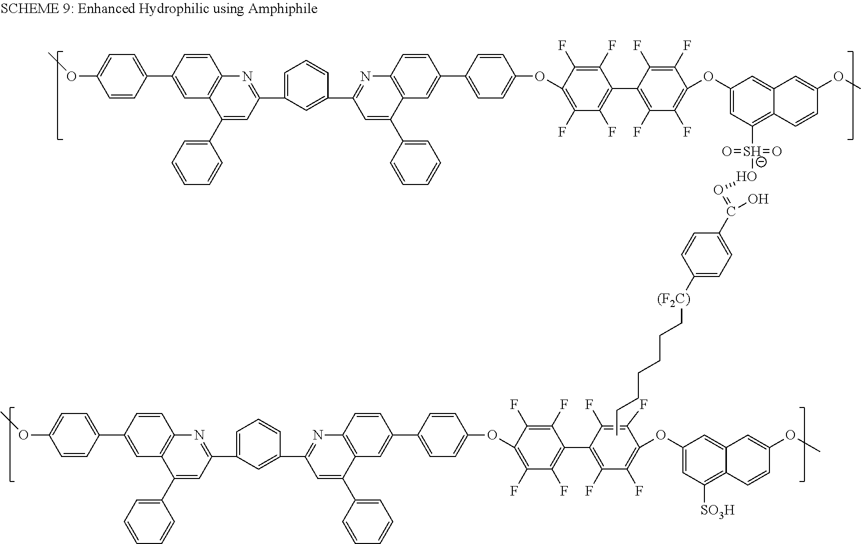

The foregoing polymer matrices and/or proton exchange membranes may be acid treated, e.g., sulfonated, after formation. Sulfonation techniques include, for example, treatment with reagents such as sulfuric acid, chlorosulfonic acid, sulfur trioxide, and/or sulfur trioxide/triethyl phosphate complex, as described in Xing, P., et al., Journal of Membrane Science 229 (2004) 95-106; Hasegawa, M., et al., Radiation Physics and Chemistry 77 (2008) 617; Di Vona, M., et al., Solid State Ionics, 179, 1161, (2008); Nolte, R., et al, Journal of Membrane Science, 83 (1993) 211-220; Manea, M., et al., Journal of Membrane Science 206 (2002) 443-453; and Noshay, A., et al., Journal of Applied Polymer Science Vol. 20, 1885-1903 (1976).

The invention may be further understood by the following non-limiting examples.

### Example 1

PEQs have been synthesized from 4,4′-difluorobenzophenone and 2,3-dihydroxyquinoxaline, as shown in Reaction 1 below.

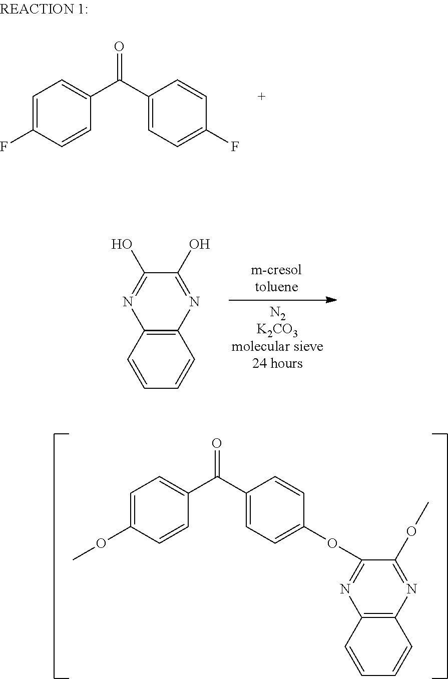

2.182 grams of 4,4′-difluorobenzophenone, 1.654 grams of 2,3-dihydroxyquinoxaline, 2.765 grams of K₂CO₃ and 4.3 grams of molecular sieves were combined in 20 mL of m-cresol and 10 mL of toluene. The resulting mixture was stirred while being heated to 175° C. for 24 hours under a nitrogen atmosphere. The PEQ was isolated after pouring the mixture into water to provide 3.636 grams of the polyetherquinoxaline product. The DSC thermogram of the resulting PEQ is shown in FIG. 4.

### Example 2

PEQs have been synthesized from bisphenol A, 4,4′-difluorobenzophenone and 2,3-dihydroxyquinoxaline, as shown in Reaction 2 below.

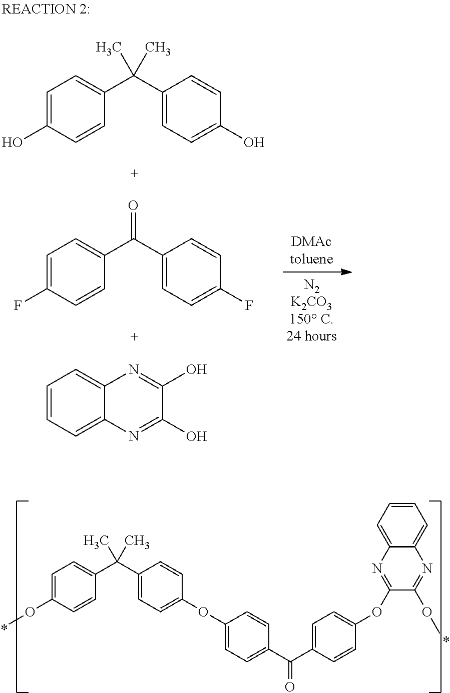

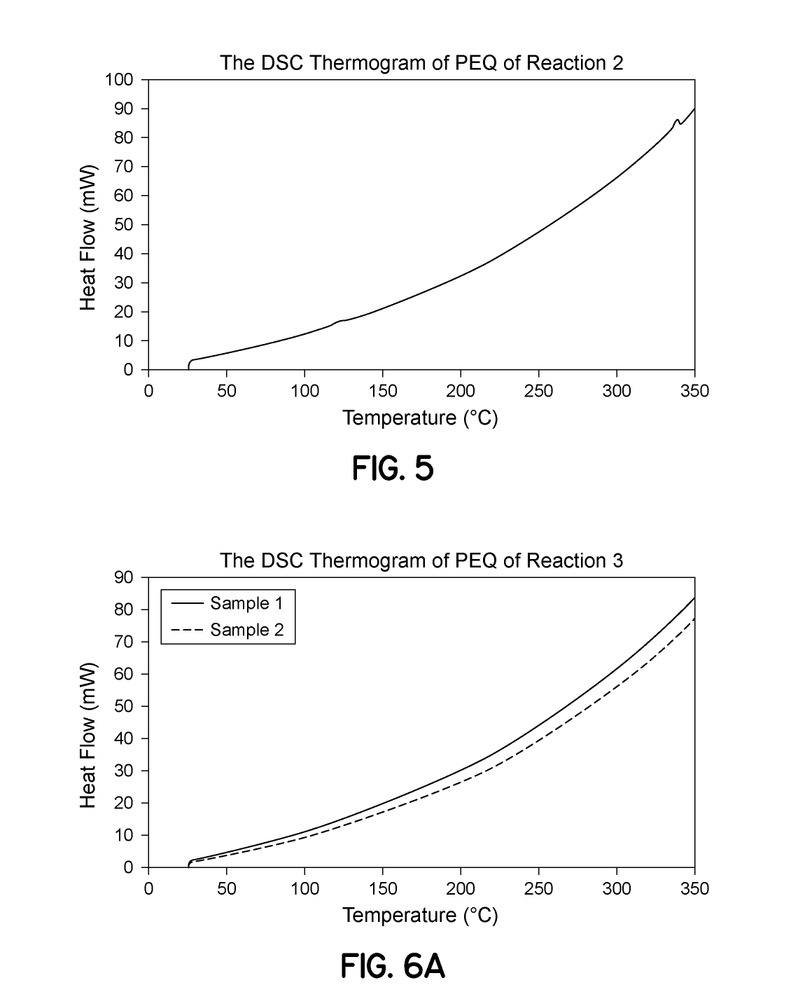

2.283 grams of bisphenol A, 4.364 grams of 4,4′-difluorobenzophenone, 1.622 grams of 2,3-dihydroxyquinoxaline, and 2.7641 grams of K₂CO₃ were combined in 40 mL of DMAc and 30 mL of toluene. The resulting mixture was stirred while being heated to 150° C. for 24 hours under a nitrogen atmosphere. The PEQ was isolated after pouring the mixture into water to provide 7.869 grams of the polyetherquinoxaline product. The DSC thermogram of the resulting PEQ is shown in FIG. 5.

### Example 3

PEQs have been synthesized from bisphenol A, bis(4-fluorophenyl)sulfone, and 2,3-dihydroxyquinoxaline, as shown in Reaction 3 below.

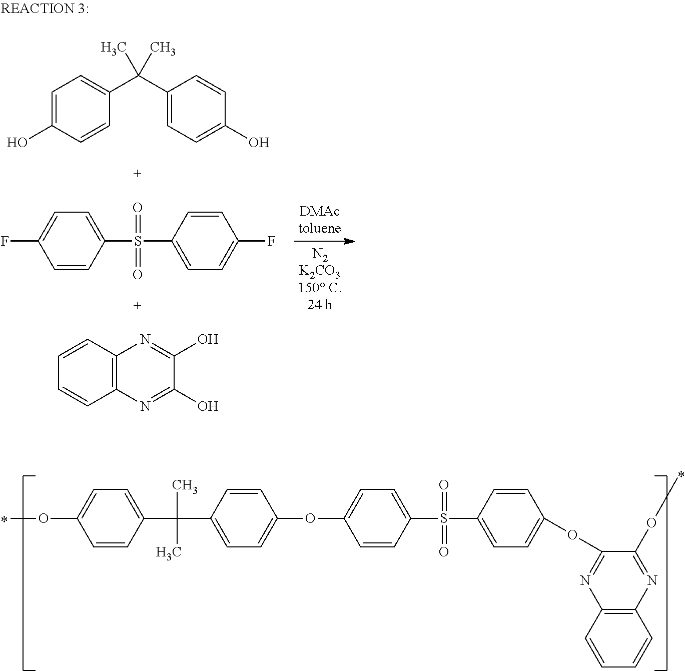

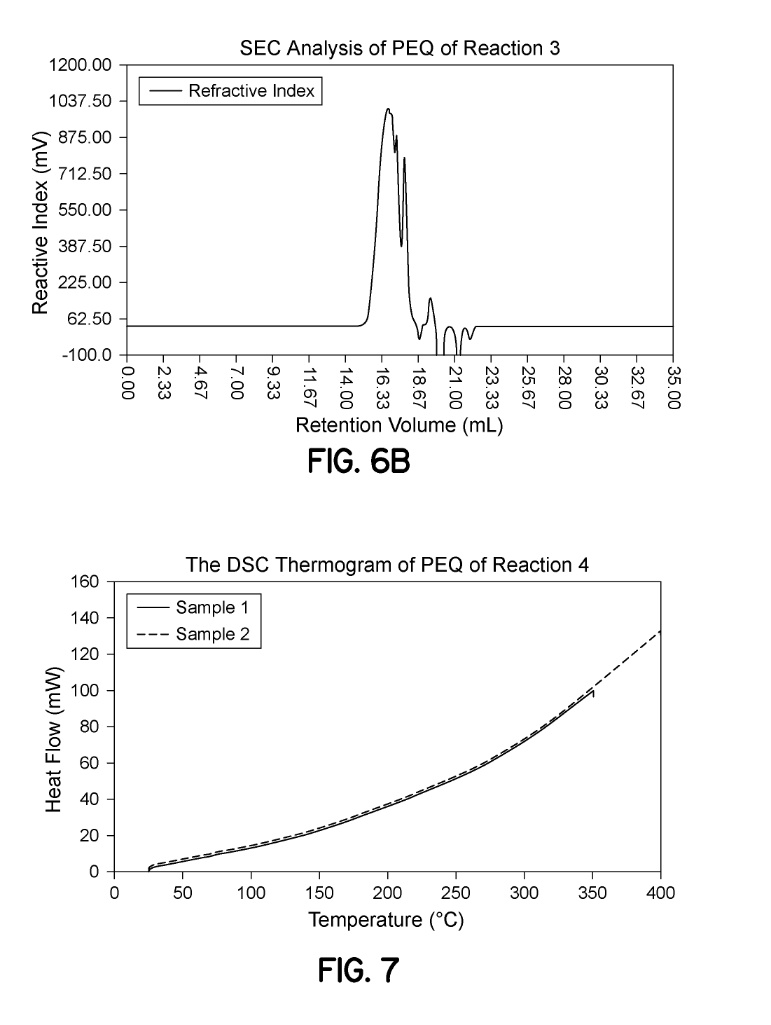

2.871 grams of bisphenol A, 5.136 grams of bis(4-fluorophenyl)sulfone, 1.654 grams of 2,3-dihydroxyquinoxaline, and 4.118 grams of K₂CO₃ were combined in 40 mL of DMAc and 30 mL of toluene. The resulting mixture was stirred while being heated to 150° C. for 24 hours under a nitrogen atmosphere. The PEQ was isolated after pouring the mixture into water to provide 9.261 grams of the polyetherquinoxaline product. The DSC thermogram of the resulting PEQ is shown in FIG. 6A. The molecular weight (MW) of the product produced in Reaction 3 above was measured using size exclusion chromatography (SEC) and a number average molecular weight (Mn) of 21,000 Da; a mass average molecular weight (Mw) of 29,000 Da; and a polydispersity index (PDI) (Mw/Mn) of 1.3. The SEC data is shown in FIG. 6B.

### Example 4

PEQs have been synthesized from 2,3-dihydroxyquinoxaline, bis(4-fluorophenyl)sulfone, and cis-2-butene-1,4-diol, as shown in Reaction 4 below.

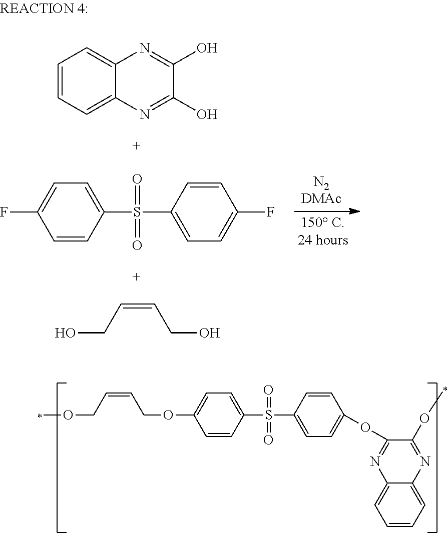

1.622 grams of 2,3-dihydroxyquinoxaline, 5.085 grams of bis(4-fluorophenyl)sulfone, 0.881 grams of cis-2-butene-1,4-diol and 2.764 grams of K₂CO₃ were combined in 40 mL of DMAc and 30 mL of toluene. The resulting mixture was stirred while being heated to 150° C. for 24 hours under a nitrogen atmosphere. The PEQ was isolated after pouring the mixture into water to provide 7.188 grams of the polyetherquinoxaline product. The DSC thermogram of the resulting PEQ is shown in FIG. 7.

### Example 5

Polyetherquinolines have been synthesized from bisphenol A and 4,7-dichloroquinoline, as shown in Reaction 5 below.

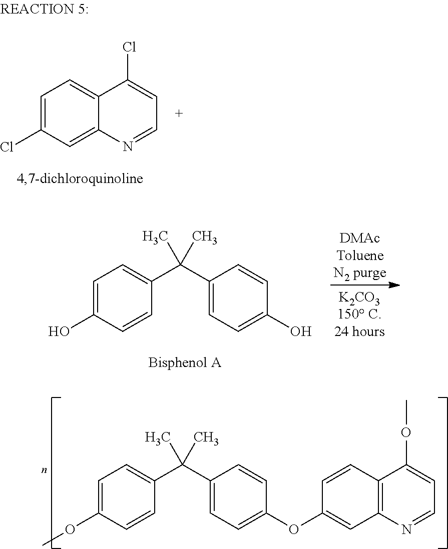

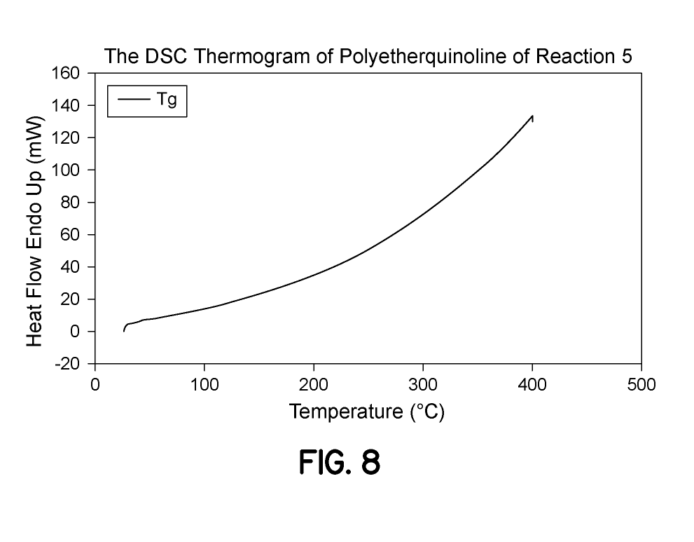

2.283 grams of bisphenol A, 1.981 grams 4,7-dichloroquinoline and 1.382 grams of K₂CO₃ were combined in 25 mL of DMAc and 15 mL of toluene and 2 grams of molecular sieves. The resulting mixture was stirred while being heated to 150° C. for 24 hours under a nitrogen atmosphere. The product was isolated after pouring the mixture into water to provide 4.037 grams of the polyetherquinoline. The DSC thermogram of the resulting polyetherquinoline is shown in FIG. 8.

### Example 6

Polyetherquinolines have been synthesized from 4,4′-difluorobenzophenone, bisphenol A and 2,6-dihydroxyquinoline, as shown in Reaction 6 below.

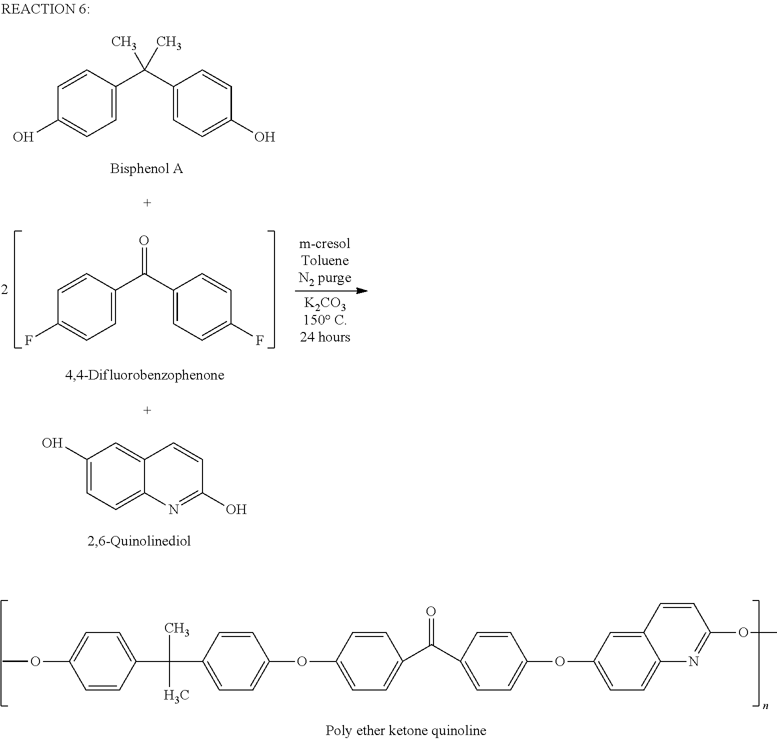

0.685 grams of bisphenol A, 1.309 grams of 4,4′-difluorobenzophenone, 0.484 grams of 2,6-dihydroxyquinoline, and 0.84 grams of K₂CO₃ were combined in 14 mL of m-cresol and 9 mL of toluene. The resulting mixture was stirred while being heated to 150° C. for 24 hours under a nitrogen atmosphere. The product was isolated after pouring the mixture into water to provide 2.25 grams of the polyetherquinoline product.

### Example 7

Polyetherquinolines have been synthesized from bis(4-fluorophenyl)sulfone and 2,4-dihydroxyquinoline, as shown in Reaction 7 below.

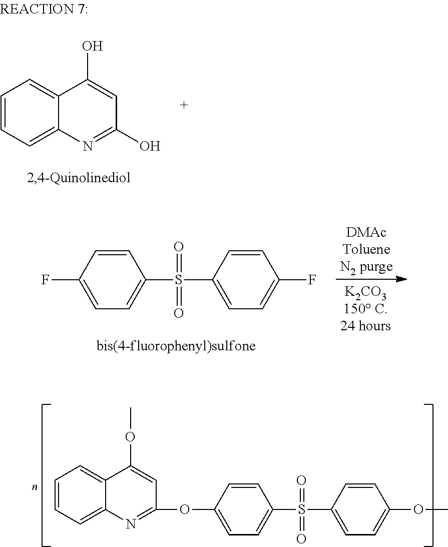

1.612 grams of 2,4-dihydroxyquinoline, 2.543 grams bis(4-fluorophenyl)sulfone and 1.4 grams of K₂CO₃ were combined in 25 mL of DMAc and 10 mL of toluene. The resulting mixture was stirred while being heated to 150° C. for 24 hours under a nitrogen atmosphere. The product was isolated after pouring the mixture into water to provide 3.955 grams of the polyetherquinoline.

### Example 8

Polyetherquinolines have been synthesized from 4,4′-difluorobenzophenone, 2,4-dihydroxyquinoline and bis(4-fluorophenyl)sulfone, as shown in Reaction 8 below.

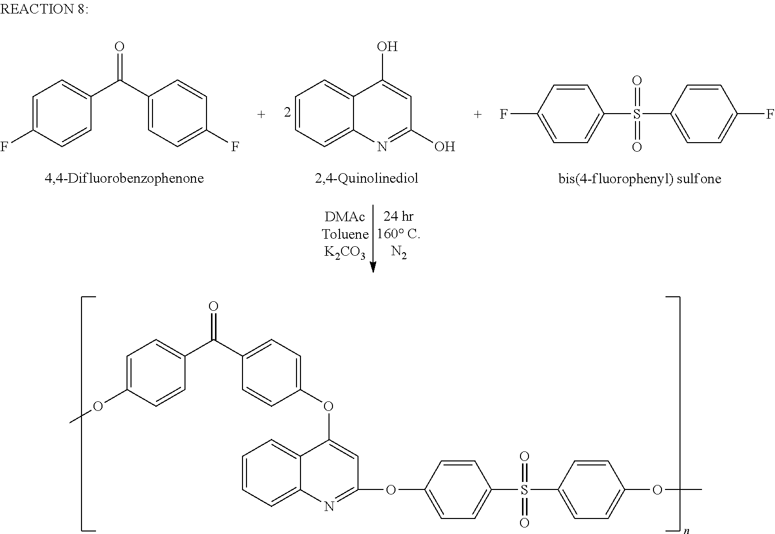

1.091 grams of 4,4′-difluorobenzophenone, 1.612 grams of 2,4-dihydroxyquinoline, 1.271 grams bis(4-fluorophenyl)sulfone, and 1.4 grams of K₂CO₃ were combined in 30 mL of DMAc and 6 mL of toluene. The resulting mixture was stirred while being heated to 160° C. for 24 hours under a nitrogen atmosphere. The product was isolated after pouring the mixture into water to provide 3.45 grams of the polyetherquinoline product.

### Example 9

Supramolecular Proton Exchange Membranes based on Heteropolyacid Composites with Polyimides and Terpyridine Linkages: Hydrophobic and hydrophilic portions of the polyimide (PI) are synthesized separately and then terpyridine linked as illustrated in FIG. 2. The hydrophobic portion of the PI can be synthesized from reactions with 1,4,5,8 naphthalene tetracarboxylic dianhydride (NTCDA) and 4,4′(9-fluoroenylidene)dianiline in m-cresol/1-methyl-2-pyrrolidone/benzoic acid. The hydrophilic portion of the PI can be obtained by sulfonating this monomer or the diamine of a different monomer.

If membrane brittleness and cracking are a problem, the membrane can be formed of a polyimide gel. These polyimide gel membranes can be coordinated polyimide membranes in which residual plasticizer remains, this plasticizer may be the solvent in which the membrane is synthesized (m-cresol) or another, more suitable solvent (such as N-octyl-1-pyrrolidone). These nano-structured polyimide membranes can also be used to prepare composite PEM's using phosphotungstic acid (PWA), silicotungstic acid (SiWA), phosphomolybdic acid (PMoA) or silicomolybdic acid (SiMoA). In an embodiment, the controlled hydrophobic/hydrophilic regions of the nanostructure polyimide membrane may be bridged by the HPA nanoparticles. It is believed that this bridging effect can further decrease the hopping resistance between HPA particles.

### Example 10

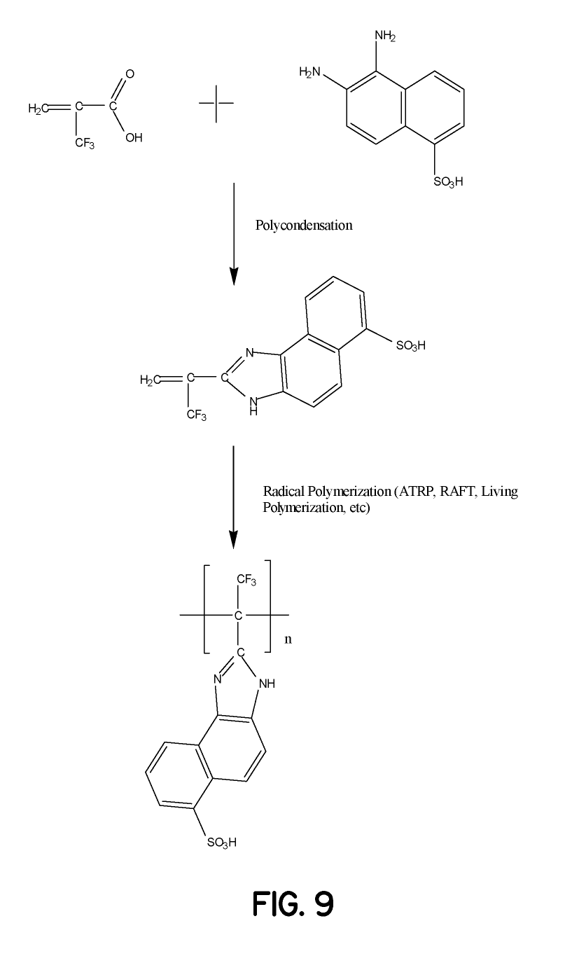

Supramolecular Proton Exchange Membranes based on Polymers Incorporating Sulfonic Acid/Imidazole and Metal Coordination Functional Groups: Sulfonic acid/imidazole functionalized polymers may be synthesized via the reaction shown in FIG. 9. An acrylic monomer is synthesized in the first step by a reaction between the carboxylic acid-terminated acrylate and sulfonic acid-functionalized aromatic amine. Radical polymerization is then carried out to create the polymer shown below. Both acrylic monomer and sulfonated diamine are commercially available (Sigma Aldrich, Product Nos. 369144 and R396966). The imidization reaction proceeds at 200° C. in polyphosphoric acid. Both atom transfer radical polymerization (ATRP) and reversible addition (chain) fragment transfer (RAFT) reactions can be used. These reactions can be carried out at 80° C. in N-methylpyrrolidone. The initiator for ATRP is trichlorosilane and the reactive complex is Spartein/CuBr/CuBr₂. The initiator for RAFT is azobisbutyronitrile (AIBN).

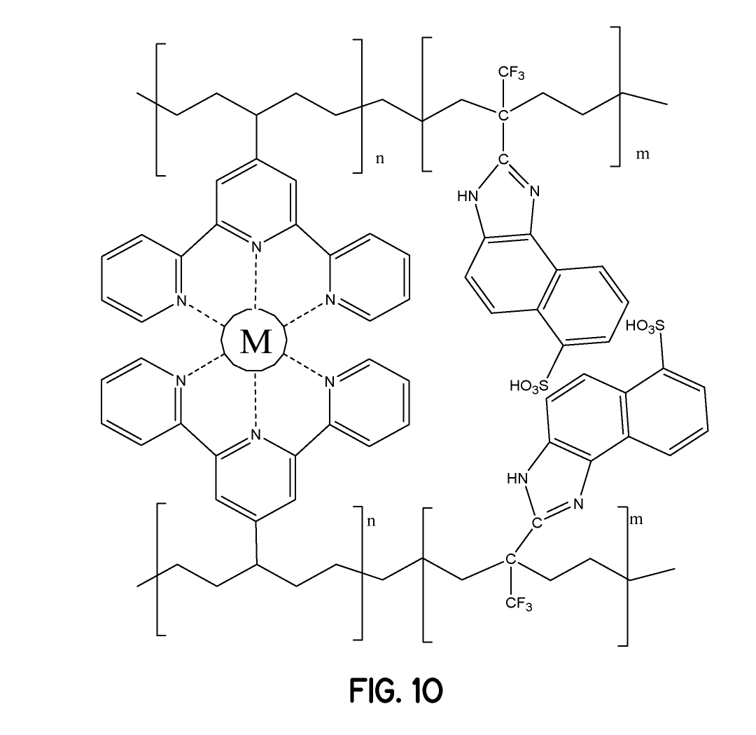

Metal-coordinated crosslinkers can be synthesized. Sulfonic acid, imidazole functionalized polymer (the synthesis described above, FIG. 9) can be copolymerized with vinyl terpyridine monomer. Terpyridine functionalized polymer can be synthesized by reaction of vinyl terpyridine monomers in which the vinyl groups are attached to either the 4 or 4′ monomers. The copolymer is synthesized by acrylic free radical polymerization at 80° C. using AIBN as initiator. Metal coordination can be accomplished using ruthenium. This reaction can be carried out at 60° C. in n-butanol, ethanol, ammonium hexafluorophosphate, and diisopropylethylamine. Other metallic ions which can be used include: zinc, copper, cobalt, and iron. FIG. 10 illustrates the metal-coordinated supramolecular fluorinated/sulfonated block copolymer via ATRP/Polycondensation.

It is expected that unique proton transport behavior will be observed because of the electronic configuration of the metal center. The metal center can also be removed after the polymer is fully crosslinked. This can provide permanent electronic channels for facilitated proton transport and thus increased proton conductivity. The removal of the metal center can be accomplished by reacting the fully polymerized metal organic framework in acidified solutions (hydrochloric and sulfuric acid). In addition, in order to stabilize the metal center after acid removal, the counterions can be reacted with salts including: sodium chloride, sodium sulfate, sodium phosphate, and sodium nitrate.

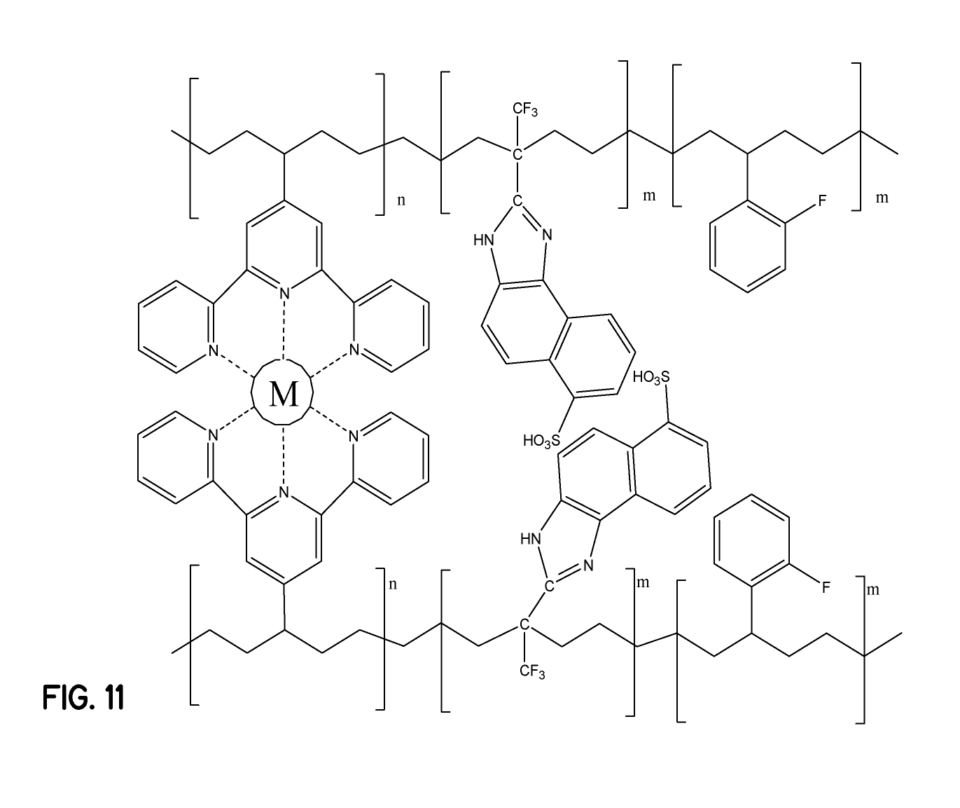

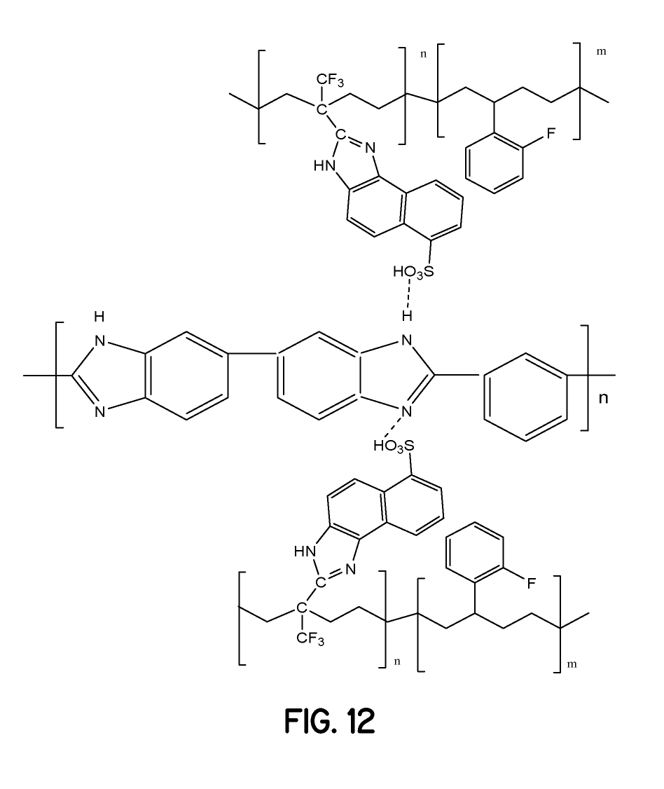

The supramolecular triblock copolymer shown in FIG. 11 may be synthesized by combining the polymers described above. Acrylic monomers containing metal coordinated, polymerized imidazole and fluorinated styrene are reacted using free radical polymerization.

### Example 11

Supra molecular Polymer based on a Blend of Polybenzimidazole (PBI) and a Fluorinated, Sulfonated Diblock Copolymer: Synthesis of the supramolecular polymer shown in FIG. 11 is accomplished by reaction between PBI which is synthesized first and blended with a block copolymer. This leads to the acid/base complex formation between the sulfonic acid group and imidazole nitrogen of PBI. The synthesis of the polymerized imidazole is carried out as described above. However, in this case the copolymer is formed with an acrylic monomer containing fluorinated styrene. The copolymer reaction is performed at 60° C. using ATRP utilizing trichlorosilane as an initiator and the reactive complex Spartein/CuBr/CuBr₂. The blending of the PBI and copolymer is done at 80° C.

The effect of the copolymer crystallinity can be assessed by varying the sulfonic acid imidazole content to the nitrogen PBI content of the copolymer. In an embodiment, this stoichiometric ratio is varied from 1:1 to 1:4. The stoichiometric ratio affects the hydrogen bonding, the proton conductivity and the mechanical properties of the copolymer.

### Example 12

Composite Membranes with Heteropolyacids (HPAs): Composite proton exchange membranes have been prepared from non-fluorinated polymer and non- and surface-coated heteropoly acids (HPA) using atom transfer radical polymerization (ATRP). Polyether sulfone (PES) was used as a polymer matrix. Phosphotungstic acid (PWA), phosphomolybdic acid (PMoA) and silicotungstic acid (SiWA) were used as HPA. It was found that the SiWA has a higher conductivity compared with PWA, at the same concentration. PES was sulfonated using chlorosulfonic acid. The highest conductivity for sulfonated PES with 60 wt % PWA was 1.7×10⁻² S/cm. In order to increase the compatibility between SiWA and PES, the SiWA was surface-coated. Surface-coated SiWA particles can be added to the polymer matrix up to 50 wt % to form a homogeneous membrane. This route also has the potential to increase the conductivity by sulfonation of grafted polymer backbone, and to avoid “washing out” of HPA in the fuel cell.

Synthesis of Composite Membrane: Polyether sulfone (PES, UDEL® P 1700) and polysulfone (PSf, UDEL® Polysulfone) were provided by Solvay Chemicals, Inc. PES solutions were prepared by dissolving the polymer in dimethylacetamide (DMAc) and N-methyl-pyrrolidinone (NMP) in a 250 ml round bottom flask with continuous agitation. PSf was dissolved in tetrahydrofuran (THF). 12% by wt polymer solutions were prepared. The composite membranes were cast in a Teflon mould by adding HPAs to the polymer solution. The HPA concentration varied from 30-70 wt %. Three types of HPAs were investigated: phosphomolybdic acid (PMoA), phosphotungstic acid (PWA) and silicotungstic acid (SiWA).

The highest HPA % of the composite membranes prepared was 70% by weight. Two HPAs; phosphotungstic acid and phosphomolybdic acid were used for 70% samples. Additional HPA in the membrane showed the signs of saturation. Silicotungstic acid could not be added more than 50% by wt to PES or it produced a poor membrane.

Acid doping is the process of introduction of a H₂PO₄⁻ to the polymer to increase the overall conductivity of the membrane. This is done by immersing the dry polyimide composite membrane prepared in 85% phosphoric acid for 6 hours. After 6 hours, the membrane was removed from the acid solution and was washed with DI water before it was tested for conductivity. For conductivity studies, a rectangular piece of the acid doped composite membrane was cut and placed on a four probe conductivity cell.

Surface Polymerization of HPA by ATRP: Polymer coating of HPA is done in order to prevent the HPAs from being washed out of the membrane. In addition, functional groups attached to the polymer can provide enhancement of proton conductivity because they can be reacted with sulfonic acid.

Atom Transfer Radical Polymerization was used as a surface polymerization technique. The surface initiator is grafted onto the HPA surface and is initiated by electrons from the redox reaction of metal halide (CuBr). Then the monomer is initiated and followed by propagation and termination.

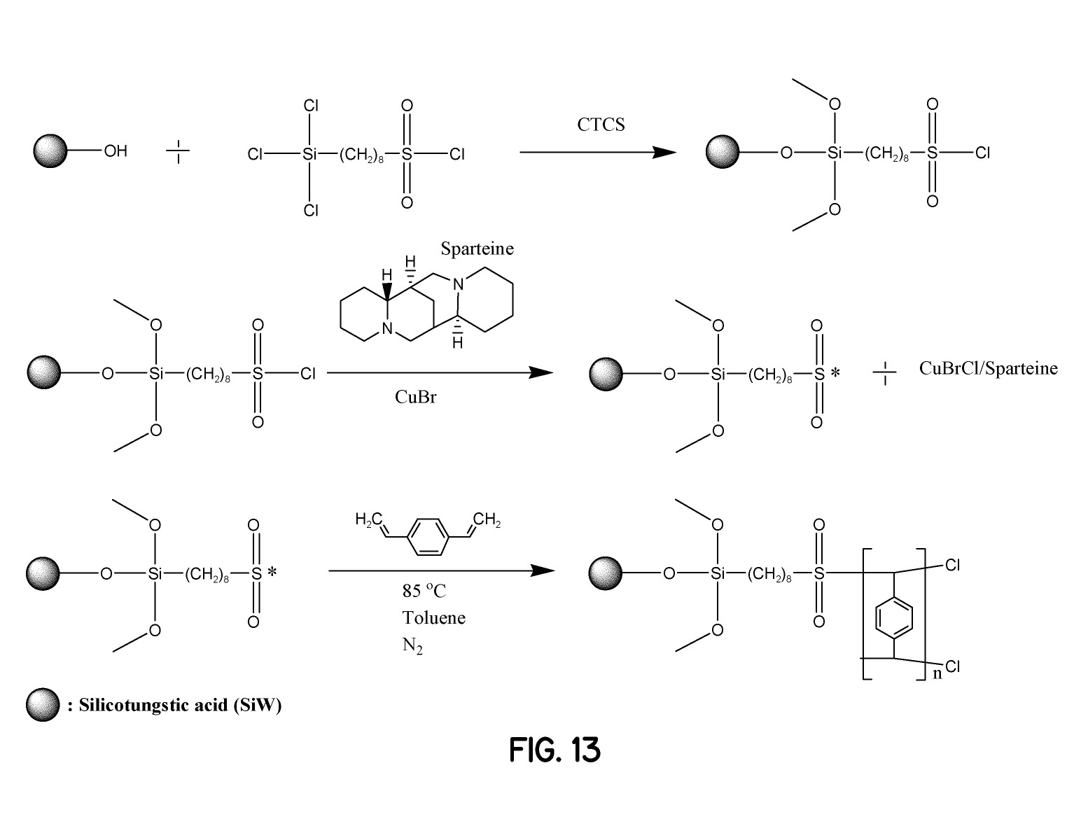

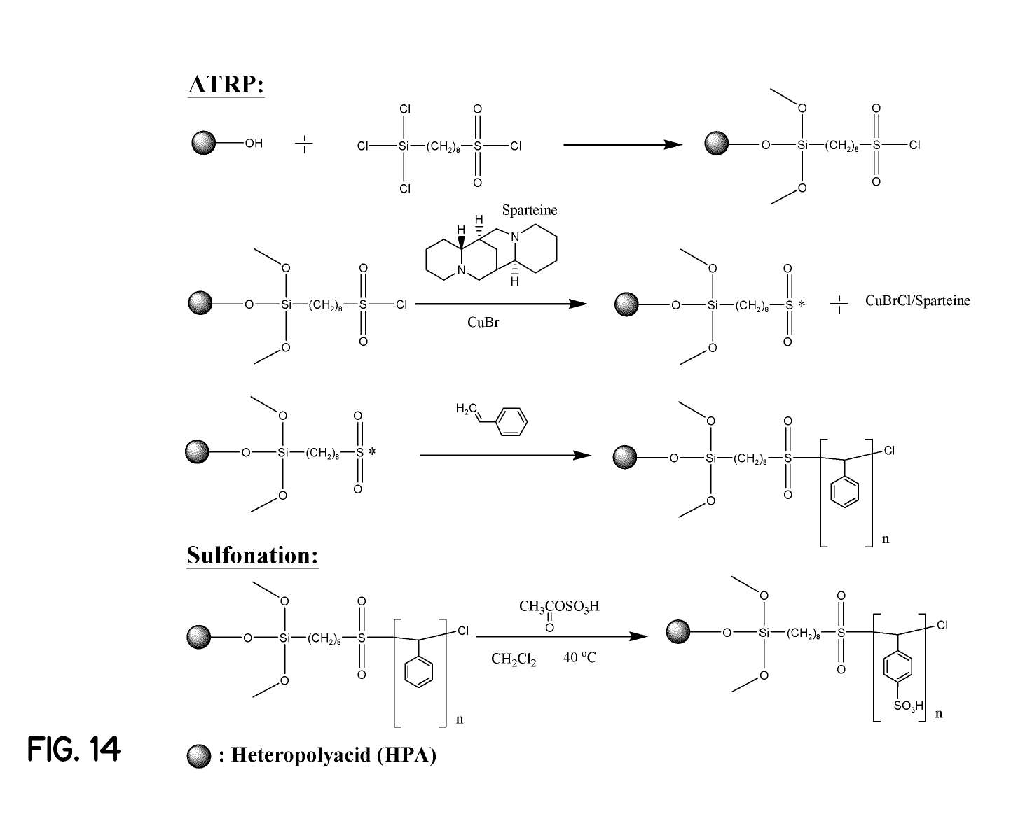

The procedure for coating SiWA particles using a divinyl benzene monomer was performed as described in Example 11. The ATRP method for coating silicotungstic acid (SiWA) using divinylbenzene as the monomer is shown in FIG. 13. A method of surface polymerization HPA using ATRP technique with styrene monomer and the sulfonation of the grafted polystyrene is shown in FIG. 14. The grafted polystyrene can be sulfonated through the reaction with acetyl sulfate in dichloromethane at 40° C.

Membrane Characterization

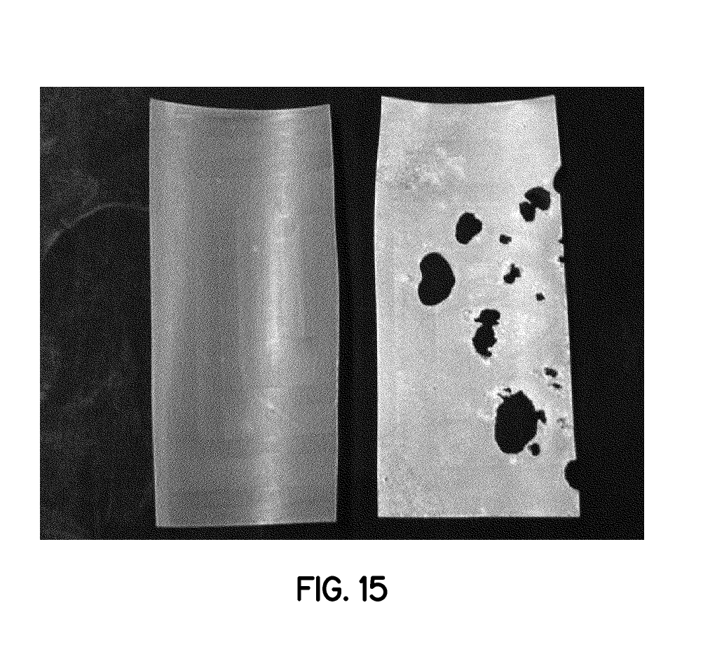

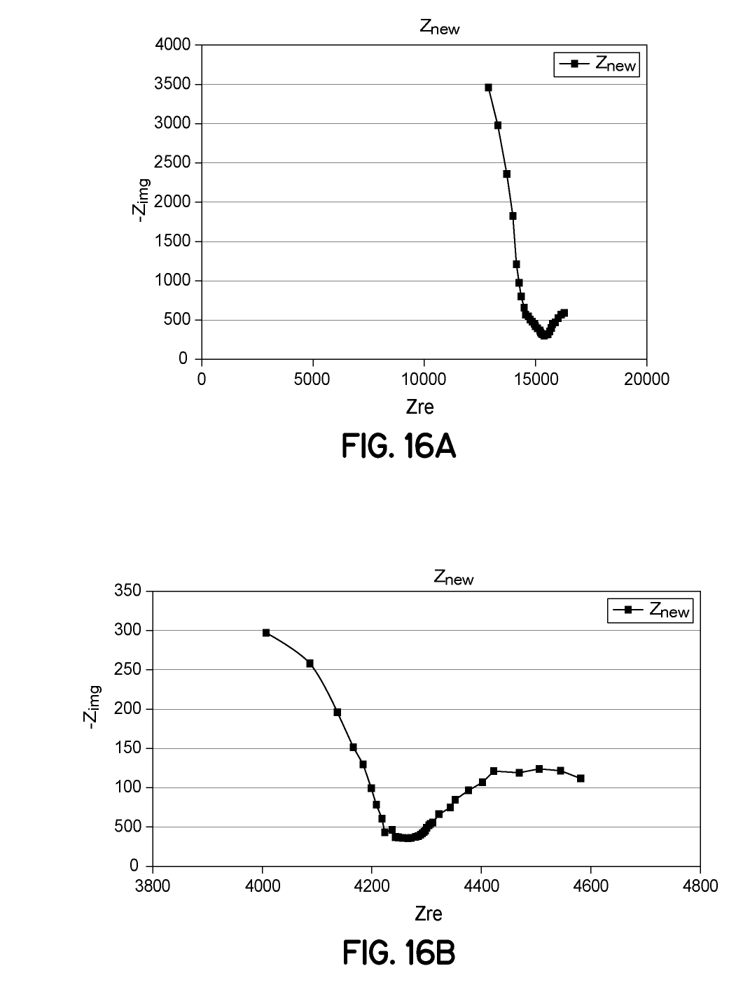

The membranes with high HPA concentration were brittle. The HPA content within the composite membrane could be increased when the HPA was coated with a surface polymerized polymer layer of divinyl benzene. Photographs of surface-coated (left) and non-surface-coated (right) SiWA composite membrane are shown in FIG. 15 for comparison. The higher quality of the surface-coated SiWA composite membrane indicates that the interface compatibility of polymer matrix and HPA may have been increased by the surface coating.

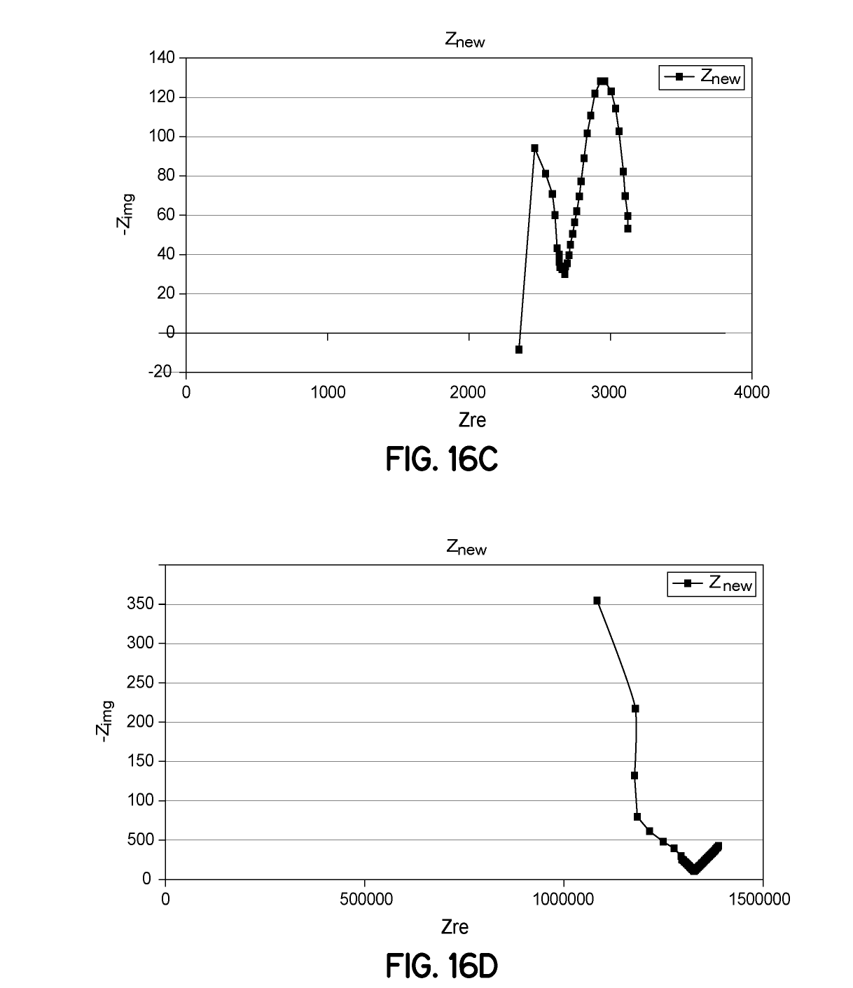

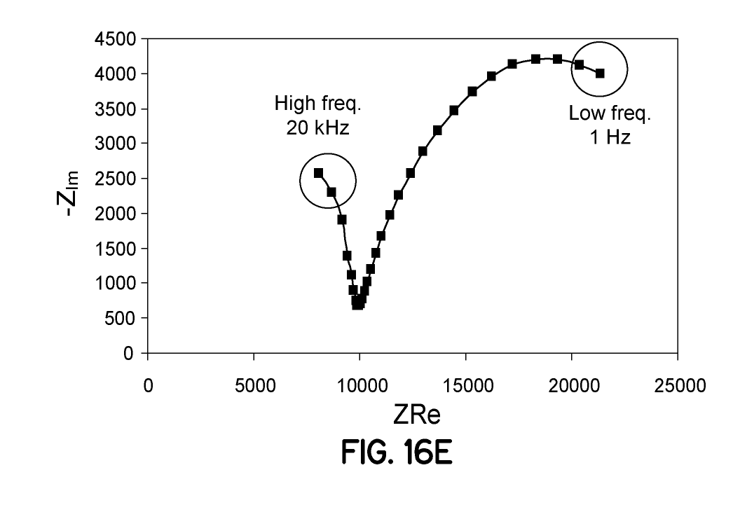

Characterization of the composite membranes was done using an electrochemical impedance meter. The conductivities were measured from 1 Hz to 1 MHz at 700 mV potential. The four point probe method was used to check for the conductivity of the membranes. Electrochemical impedance spectroscopy (EIS) was used to measure the conductivity of the membranes. FIG. 16A shows the EIS of composite membrane with 50% phosphotungstic acid. The conductivity of the composite membrane was observed to be 1.825×10⁻³ S/cm. FIG. 16B is the EIS plot of composite membrane with phosphotungstic acid and PES. The HPA concentration is 60% by wt. The conductivity measured for this composite membrane is 4.3×10⁻³ S/cm. This conductivity was higher than the composite membrane with 50% HPA concentration. The increased conductivity suggests that the higher the HPA concentration in the membrane, the higher is the conductivity observed. However, for 70% HPA content, the polymer reached its saturation and HPA separated from the homogenous membrane. FIG. 16C shows that the conductivity of a composite membrane with 50% silicotungstic acid and PES is 6.7×10⁻³ S/cm. This shows that though the concentration of silicotungstic acid is lower than the others, it exhibited highest conductivity. The EIS plot in FIG. 16D is the Nyquist plot for the pure PES membrane. It showed the lowest conductivity of all the composite membranes. This shows that the addition of HPA to the pure polymer increases the overall membrane conductivity.

Table 1 below shows the conductivities for several composite membranes. As expected, the presence of HPA increases the membrane conductivity. However, at high concentration of HPA the mechanical stability of the composite membrane decreases.

Silicotungstic acid makes the membrane more brittle as compared to other HPAs added in the same amount (50 wt %). The surface-coated HPA can be used for enhancing the SiWA content in a composite membrane without decreasing the mechanical properties. The results indicate that 50% SiWA non-coated provides better conductivity than even 70% of other HPAs. The higher conductivity, as high as acid doped membrane, of composite membrane without acid doping can be achieved if the concentration of HPA is higher or equal to 50 wt %. The lower conductivity of the membranes fabricated with surface-coated HPA may be due to the low proton conductivity of the polymer used for surface coating.

The Nyquist plot of acid doped composite polyimide (3.4 wt. % HPA and 85% H₃PO₄ doped) is shown in FIG. 16E. In addition to the curve shown on the left hand side, the peak on the right side represents the Warburg impedance behavior.

TABLE 1
Conductivities of composite membranes at 100% RH and room temperature.

| Membranes | Conductivity (S/cm) |
|---|---|
| 60 wt % PWA-acid doped (85% H₃PO₄) blend PES/PBI (40 wt % PES) | 2.8 × 10⁻² |
| 60 wt % PWA-acid doped (85% H₃PO₄) blend PES/PBI (10 wt % PES) | 2.6 × 10⁻² |
| 50 wt % SiWA- blend PES/PBI (10 wt % PBS) | 2.1 × 10⁻² |
| 40 wt % PWA-acid doped (85% H₃PO₄) blend PES/PBI (40 wt % PES) | 2.1 × 10⁻² |
| 40 wt % SiWA- blend PES/PBI (10 wt % PES) | 8.7 × 10⁻³ |
| 60 wt % PWA - SPES Type 3 | 1.7 × 10⁻³ |
| 30 wt % SiWA - SPES Type 3 | 6.1 × 10⁻³ |
| 70 wt % PWA - PES | 5.1 × 10⁻³ |
| 60 wt % PWA - PES | 4.3 × 10⁻³ |
| SPES Type 3 (sulfonated with 20 mL chlorosulfonic acid) | 3.6 × 10⁻³ |
| SPES Type 2 (sulfonated with 25 mL chlorosulfonic acid) | 8.1 × 10⁻³ |
| SPES Type 3 (sulfonated with 10 mL chlorosulfonic acid) | 6.9 × 10⁻³ |
| 3.4 wt % PWA - acid doped (85% H₃PO₄) polyimides | 2.5 × 10⁻³ |
| 3.4 wt % PWA - polyimides | 5.3 × 10⁻³ |
| 50 wt % PWA - PES | 1.8 × 10⁻³ |
| 70 wt. % PMoA - PES | 0.8 × 10⁻³ |
| 60 wt % SiWA (coated with sulfonic acid terminated silane)-PES | 2.0 × 10⁻² |
| 50 wt % SiWA (coated with sulfonic acid terminated silane)-PES | 1.6 × 10⁻² |
| 50 wt % SiWA (coated with polydivinylbenzene)-PES | 1.4 × 10⁻³ |
| 50 wt % SiWA (non-coated)-PES | 6.7 × 10⁻³ |
| PSf (pure) | 8.1 × 10⁻⁵ |
| PES (pure) | 3.2 × 10⁻⁵ |

### Example 13

Surface Coating of HPAs: Preparation of silicotungstic acids (SiWA) and grafting polymer onto SiWA surface using ATRP: Silicotungstic acid (16 g) was dried in the vacuum oven at 100° C. overnight and stored in a desiccator. SiWA was pulverized manually using a mortar and pestle and sieved using 270 mesh sieves. Dried SiWA particles (12 g) were added and reacted at 85° C. with 4 grams of 2-(4-chlorosulfonylphenyl)-ethylrichlorosilane (CTCS) for 36 hours in anhydrous toluene (110 g) in inert gas (nitrogen). The mixture was then filtered and washed with anhydrous toluene in order to remove excess CTCS. The residue (SiWA-CTCS) was dried in a vacuum oven at low temperature (50° C.) for 24 hours. Functionalized SiWA-CTCS (6 g) was reacted with CuBr (0.06 g), CuBr₂ (0.03 g), Spartein (0.06 g), and monomer (divinylbenzene) in anhydrous toluene (60 g) at 85° C. for 24 hours under nitrogen. Finally, the mixture was filtered, washed several times with anhydrous toluene and dried in a vacuum oven at low temperature (50° C.) prior to use. The scheme of surface polymerization of SiWA using ATRP is shown in FIG. 13.

Fourier Transform Infrared (FTIR) Spectroscopy

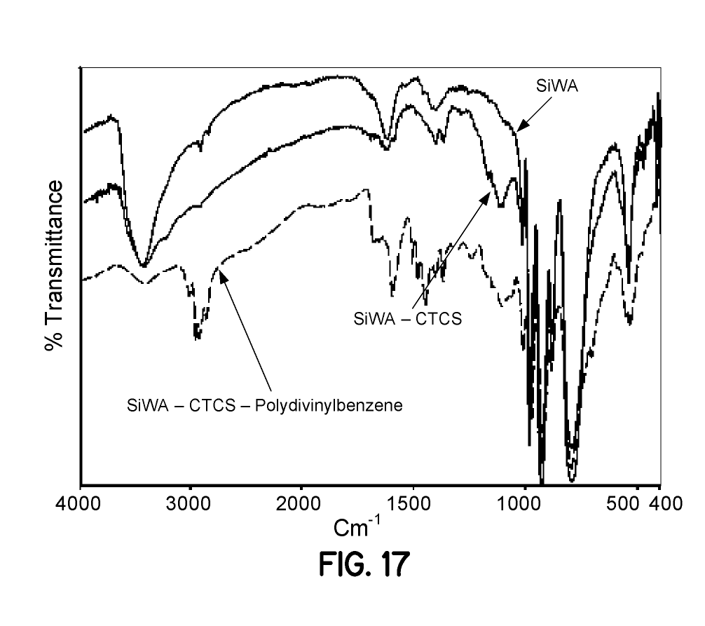

The grafted surface initiator and polymer on the SiWA particle was characterized using FTIR. The sample was scanned from 400 to 4000 cm⁻¹. Transmission data of infrared spectra for uncoated SiWA particles, SiWA particles—CTCS, and SiWA particles—CTCS—poly(divinyl benzene) are shown in FIG. 17. Comparing the curves of SiWA and SiWA—CTCS, an absorbance peak indicating a silanol stretch bond (Si—O) exists at about 1100 cm⁻¹, and a peak is shifted at 1400 cm⁻¹, which represents the sulfur dioxide bond stretch (SO₂) from the surface initiator (CTCS). On the SiWA—CTCS—poly(divinyl benzene) infrared spectra, another peak appears at about 1600 cm⁻¹, which represents the presence of a double bond (C═C) of poly(divinyl benzene). By comparing the infrared spectra among SiWA, SiWA particles—CTCS, and SiWA particles—CTCS—poly(divinyl benzene), it can be concluded that the polymer has been successfully covalently bonded on the surface of SiWA particles through a silane-based surface initiator.

Differential Scanning Calorimetry (DSC)

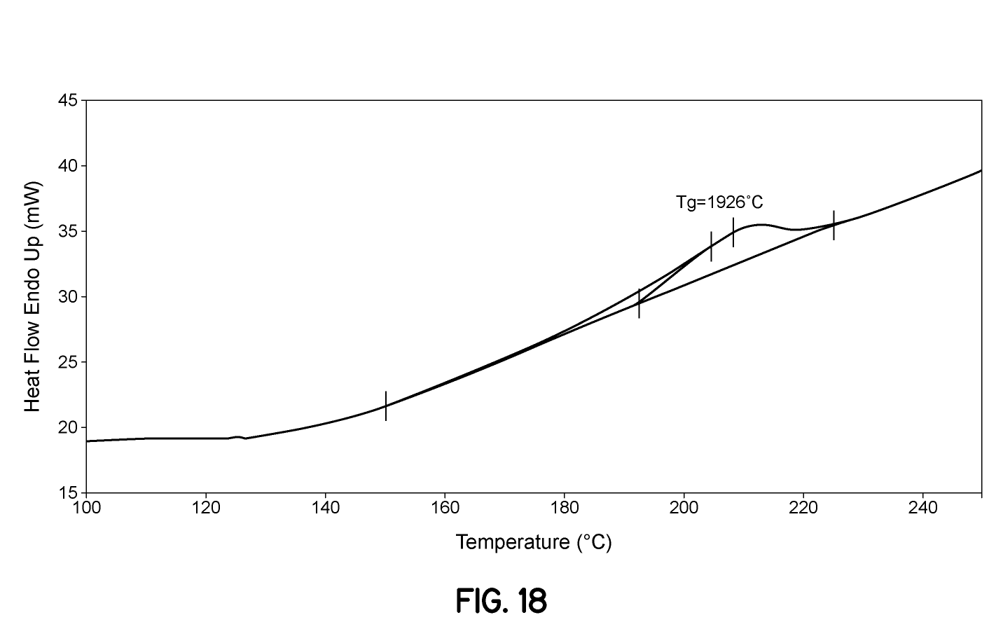

The glass transition temperature (Tg) of grafted polymer on the surface of SiWA particles were characterized using DSC. A standard method has been used for temperature scanning from 50° C. to 350° C. at a heating rate of 10° C./min. The temperature scanning has been done under high purity nitrogen purge with volumetric flow rate of 20 ml/min. The grafted poly(divinyl benzene) on the SiWA surface showed the thermal transition temperature at 192.6° C. The poly(divinyl benzene) synthesized in our laboratory has a higher thermal transition temperature than the bulk poly(divinyl benzene), which has thermal transition temperature of 150-158° C. Higher glass transition temperature for grafted polymer is believed to be due to the covalently bonded polymer onto the surface that restricts the mobility of molecules. As a result, higher energy is required to achieve the glassy state of the grafted polymer before reaching glass transition temperature. The DSC curve for grafted polydivinylbenzene on the SiWA particles is shown in FIG. 18.

Optical Microscopy

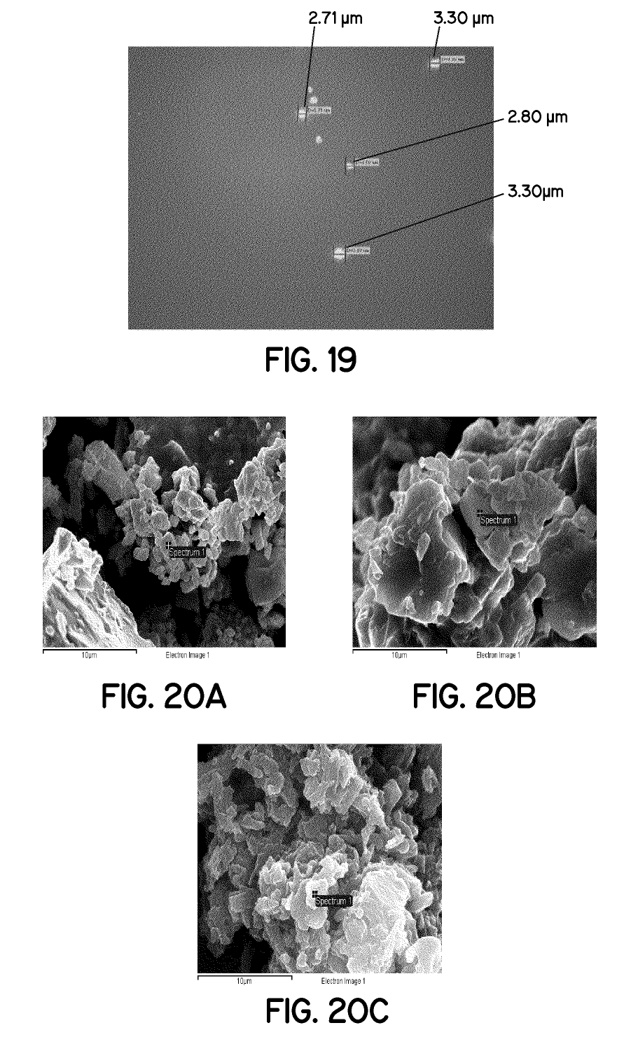

The shape of the SiWA particles was not spherical and the size distribution was under 10 μm. The SiWA particle size was reduced by grinding prior to composite membrane preparation. The reduced size of the ground SiWA particles was measured using optical microscopy. The average diameter of ground SiWA particles was about 2.50-3.50 μm. The particle size distribution is shown in FIG. 19.

As described above, surface coating the SiWA particles increases the amount of SiWA that can be added into polymer matrix (PES) without any compatibility issue, i.e., saturated concentration of HPA in polymer matrix was observed at 50 wt % without polymer coating of the SiWA. In addition, the mechanical properties of surface grafted polymer composite membrane was maintained and the “washing out” of HPAs, because the HPAs are hydrophilic, under humidified conditions would be possible to avoid. However, the conductivity of surface-coated SiWA composite membrane was observed to be lower than that of a non-surface-coated SiWA composite membrane, as shown in Table 1. A comparison picture showing a surface-coated and a non-surface-coated SiWA composite PES membranes (50 wt %) is shown in FIG. 15.

Scanning Electron Microscopy with X-ray Energy Dispersive Spectrum (SEM-XEDS)

Characterization and identification of SiWA particles, SiWA particles—CTCS, and SiWA particles—CTCS—poly(divinyl benzene) were performed with a high-resolution scanning electron microscope equipped with X-ray energy dispersive spectrum (SEM-XEDS) by Hitachi S-4700 equipped with an Oxford EDS System. Samples were subjected to platinum sputter coating, prior to observation, to prevent the charging of the organic compound, to distribute the effects of heating, and to increase the intensity of secondary and back-scattered electrons at high resolution. Appropriate selection of the electron beam acceleration voltage is required to avoid thermal degradation of sample, especially organic material, and to achieve accurate element quantification. The electron beam acceleration voltage used during this observation was 20 keV. The shape of the SiWA particles was not spherical and the size distribution was as expected, under 10 μm. The SiWA particles were agglomerate after immobilization of surface initiator (CTCS). However, the surface grafted poly(divinyl benzene)—SiWA particles were in the smaller distribution particles size. It may be caused by polymerization process which poly(divinyl benzene) prevented the aggregation of SiWA particles. The SEM micrographs of SiWA particles, SiWA with surface immobilized CTCS, and the grafted poly(divinyl benzene) on the surface of SiWA particles, are shown in FIG. 20A-C. FIG. 20A-C shows SEM micrographs of; (A) SiWA particles, (B) SiWA with surface immobilized CTCS, and (C) the grafted poly(divinyl benzene) on the surface of the SiWA particles of (B).

Elemental Analysis with X-ray Energy Dispersive Spectrum (XEDS)

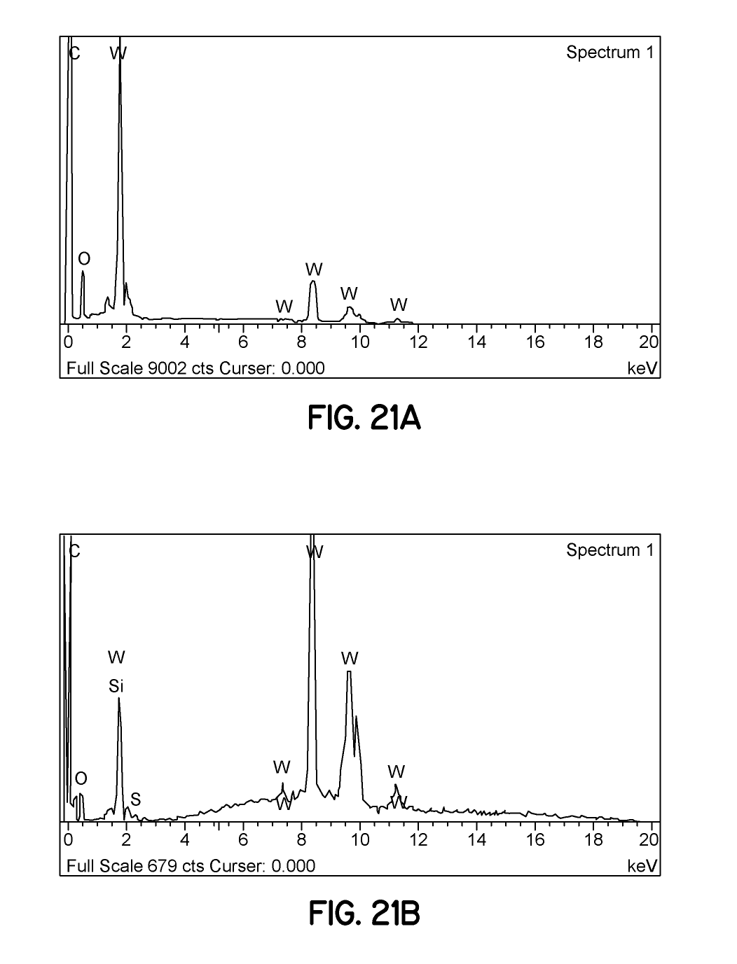

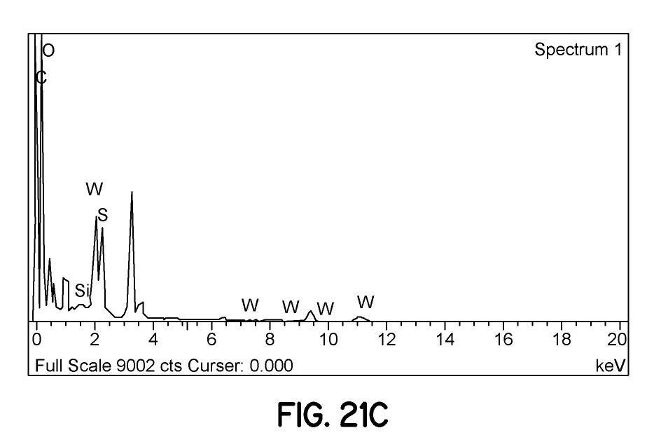

Quantitative elemental analysis was recorded by x-ray energy dispersive spectrograms and Oxford XEDS System. During scanning, x-ray peaks were generated and used to record the elements that existed on the SiWA and SiWA modified particles. The elemental maps for the identified elements were also generated automatically during the scanning time. The electron beams may penetrate only a few nanometers in depth of sample surface. Because of that limitation, XEDS analysis was aimed only to determine the occurrences of immobilization of surface initiator (CTCS) and the polymerization of poly(divinyl benzene) on the SiWA particles. The XEDS spectrograms are shown in FIGS. 21A-C, and show energy dispersive X-ray analysis of: (A) SiWA particles, (B) SiWA with surface immobilized CTCS, and (C) the grafted poly(divinyl benzene) on the surface of the SiWA particles of (B). The number of carbon atoms increased from SiWA particles, SiWA with surface immobilized CTCS, and the grafted poly(divinyl benzene) on the surface of SiWA particles. These results confirmed that the immobilization of surface initiator (CTCS) and the polymerization of poly(divinyl benzene) on the SiWA particles occurred. Immobilization was also supported by decreasing the number of tungsten atoms after SiWA surface modification which means the SiWA particle was covered by surface initiator (CTCS) and poly(divinyl benzene) as coating. The weight percentage of each element for SiWA particles, SiWA with surface immobilized CTCS, and the grafted poly(divinyl benzene) on the surface of SiWA particles from x-ray energy dispersive spectrograms is listed in Table 2 below.

TABLE 2
Element Analysis from X-ray Energy Dispersive (X-EDS).

| | Weight % | | |
|---|---|---|---|
| Element | SiWA | SiWA-CTCS | SiWA-CTCS-poly(divinyl benzene) |
| C | 22.00 | 42.36 | 72.98 |
| O | 34.39 | 31.04 | 24.70 |
| Si | 1.64 | 1.03 | 0.01 |
| S | 0.00 | 0.74 | 2.30 |
| W | 41.97 | 24.83 | 0.02 |
| Total | 100.00 | 100.00 | 100.00 |

Surface modified silicotungstic acid (SiWA) using sulfonic acid terminated silane molecule is another approach to increase the conductivity of heteropolyacids (HPAs) composite membrane. This technique involves reaction of hydroxyl group from silane and SiWA, in which sulfonic acid terminated silane will be covalently bonded to surface of SiWA through silanol group (Si—O). The side product of this reaction will be water molecules, which can be removed by using vacuum dryer. PES/surface modified silane-SiWA composite membranes have been synthesized with two different concentrations, 50 wt % and 60 wt % of surface-modified SiWA. As a result, the conductivity of PES/surface modified silane-SiWA composite membrane was two times higher than regular composite (non-modified SiWA) with the same amount of SiWA in composite membrane (50 wt %). The relevant composite membrane conductivities are listed in Table 1. The membranes appeared homogenous and were not brittle.

Preparation of Silane-Modified Silicotungstic Acids (SiWA)

Silicotungstic acid (15 g) was dried in the vacuum oven at 100° C. overnight and stored in a desiccator. SiWA was then pulverized manually using a mortar and pestle and sieved using 270 mesh sieves. Dried SiWA particles were added and reacted at 60° C. with 3-(trihydroxysilyl)-1-propanesulfonic acid (TDPSA, 12.5 g) for 24 hours in anhydrous toluene (110 g) as a solvent in inert gas (nitrogen). The suspension was dried by evaporating the solvent in a vacuum oven at low temperature (50° C.) for 24 hours. The solid residue (SiWA-TDPSA) was pulverized and sieved prior to further use. The scheme for surface modification of SiWA using silane is shown in Scheme 10

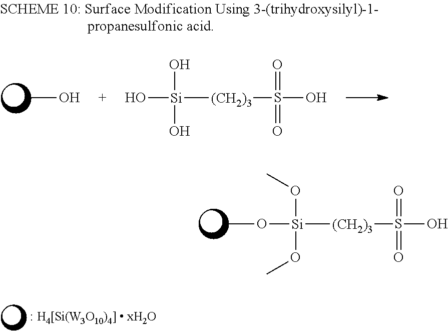

### Preparation of PES/Surface Modified Silane-SiWA Composite Membranes

PES pellets were weighed and dissolved in dimethylacetamide (DMAc) and followed by adding and mixing of surface modified silane-SiWA at room temperature (25° C.). The mixing process was completed within 2 hours in order to obtain uniform PES/silane-modified SiWA solution. Then, the solution was poured in the mold and followed by solvent vaporization in a vacuum oven overnight at a temperature in the range of 80° C. to 100° C.

Conductivity of PES/surface modified silane-SiWA composite membranes

Membrane resistance and conductivity were measured using an electrochemical impedance spectrometer with a frequency range from 1 Hz to 1 MHz. The conductivity of PES/surface modified silane-SiWA composite membranes, 1.6×10⁻² S/cm, was higher than PES/pure SiWA composite membrane, 6.7×10⁻³ S/cm, at the same concentration (50 wt %). In addition, the conductivity of 60 wt % PES/surface modified silane-SiWA composite membranes was 2.0×10⁻² S/cm.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and method and illustrative examples shown and described. Accordingly, departures may be made from such details without departing from the scope of the general inventive concept.

What we claim is:

1. A polyetherquinoxaline defined by a repeating unit including an ether linkage, the repeating unit is obtained by reaction between a haloquinoxaline and at least one diol.

2. The polyetherquinoxaline of claim 1, wherein the haloquinoxaline is selected from the group consisting of 2,3-dihaloquinoxaline; 2,6-dihaloquinoxaline; 2,3,6,7-tetrahaloquinoxaline; 2,3-dihalo-6-nitro-quinoxaline; 2,3-dihalo-6-methyl-quinoxaline; and 2,3-bis(halomethyl)quinoxaline, optionally substituted by one or more acid pendant groups selected from the group consisting of a sulfonic acid group (SO₃H), a phosphonic acid group (PO₃H₂), a carboxylic acid group (CO₂H), and salts thereof.

3. The polyetherquinoxaline of claim 1, wherein the at least one diol is selected from the group consisting of 2,3-dihydroxyquinoxaline; 2,3-dihydroxy-6-nitro-quinoxaline; 2,3-dihydroxy-6,7-dimethoxy-quinoxaline; and 2-hydroxy-3-carboxyquinoxaline.

4. The polyetherquinoxaline of claim 1, wherein the at least one diol comprises at least one hydroxyl group directly bonded to an aromatic ring.

5. The polyetherquinoxaline of claim 1, wherein the at least one diol comprises at least two hydroxyl groups, wherein each of the at least two hydroxyl groups is directly bonded to a same or different aromatic ring.

6. The polyetherquinoxaline of claim 1, wherein the at least one diol comprises at least one hydroxyl group directly bonded to a saturated carbon.

7. The polyetherquinoxaline of claim 6, wherein the at least one diol comprises at least two hydroxyl groups, wherein each of the at least two hydroxyl groups is directly bonded to a saturated carbon.

8. The polyetherquinoxaline of claim 1, wherein the haloquinoxaline is selected from the group consisting of 2,3-dihaloquinoxaline; 2,6-dihaloquinoxaline; 2,3,6,7-tetrahaloquinoxaline; 2,3-dihalo-6-nitro-quinoxaline; 2,3-dihalo-6-methyl-quinoxaline; and 2,3-bis(halomethyl)-quinoxaline, and wherein the diol is selected from the group consisting of 2,3-dihydroxy-quinoxaline; 2,3-dihydroxy-6-nitro-quinoxaline; 2,3-dihydroxy-6,7-dimethoxy-quinoxaline; and 2-hydroxy-3-carboxyquinoxaline.

9. A proton exchange membrane for a fuel cell comprising a substrate including the polyetherquinoxaline of claim 1.

10. The proton exchange membrane of claim 9, wherein the haloquinoxaline is selected from the group consisting of 2,3-dihaloquinoxaline; 2,6-dihaloquinoxaline; 2,3,6,7-tetrahalo-quinoxaline; 2,3-dihalo-6-nitro-quinoxaline; 2,3-dihalo-6-methyl-quinoxaline; and 2,3-bis(halomethyl)quinoxaline, wherein the quinoxaline moiety is optionally substituted by one or more acid pendant groups selected from the group consisting of a sulfonic acid group (SO₃H), a phosphonic acid group (PO₃H₂), a carboxylic acid group (CO₂H), and salts thereof.

11. The proton exchange membrane of claim 9, wherein the at least one diol is selected from the group consisting of 2,3-dihydroxyquinoxaline; 2,3-dihydroxy-6-nitro-quinoxaline; 2,3-dihydroxy-6,7-dimethoxy-quinoxaline; and 2-hydroxy-3-carboxyquinoxaline.

12. The proton exchange membrane of claim 9 further comprising one or more polymers and/or one or more inorganic particles.

13. The proton exchange membrane of claim 12, wherein the one or more polymers is selected from the group consisting of a polyethersulfone, a polyimide, a sulfonated tetrafluoroethylene based fluoropolymer-copolymer, polyphosphazene, polybenzimidazole, and polybenzoxazole.

14. The proton exchange membrane of claim 12, wherein the one or more polymers is substituted by one or more acid pendant groups selected from the group consisting of a sulfonic acid group (SO₃H), a phosphonic acid group (PO₃H₂), a carboxylic acid group (CO₂H), and salts thereof.

15. The proton exchange membrane of claim 12, wherein the one or more inorganic particles is selected from a heteropolyacid or a clay.

16. The proton exchange membrane of claim 15, wherein the heteropolyacid is selected from phosphotungstic acid, silicotungstic acid, phosphomolybdic acid, silicomolybdic acid, or combinations thereof.

17. The proton exchange membrane of claim 15, wherein the one or more inorganic particles is coated with a polymer.

18. The proton exchange membrane of claim 17, wherein the polymer comprises a reaction product comprising a monomer having one or more acid pendant groups selected from the group consisting of a sulfonic acid group (SO₃H), a phosphonic acid group (PO₃H₂), a carboxylic acid group (CO₂H), and salts thereof.

19. A membrane electrode assembly for a fuel cell comprising:
an anode;
a cathode; and
a proton exchange membrane including a polyetherquinoxaline defined by a repeating unit including an ether linkage, the repeating unit is obtained by reaction between a haloquinoxaline and at least one diol.

20. A method of making a polyetherquinoxaline comprising:
reacting a haloquinoxaline and at least one diol to form a polyetherquinoxaline having a repeating unit including an ether linkage.
